(19) United States
(12) Patent Application Publication
(10) Pub. No.: US 2024/0270918 A1
(43) Pub. Date: Aug. 15, 2024

(54) METHODS OF FORMING SYNTACTIC FOAMS USING SELECTIVE LASER SINTERING

(71) Applicant: Wisconsin Alumni Research Foundation, Madison, WI (US)

(72) Inventors: Pavana Prabhakar, Madison, WI (US); Hridyesh Raj Tewani, Madison, WI (US)

(21) Appl. No.: 18/439,978

(22) Filed: Feb. 13, 2024

Related U.S. Application Data
(60) Provisional application No. 63/485,038, filed on Feb. 15, 2023.

(51) Int. Cl. C08J 9/232; B33Y 10/00; B33Y 70/10; B33Y 80/00; C08K 7/28

(52) U.S. Cl. CPC C08J 9/232; B33Y 10/00; B33Y 70/10; B33Y 80/00; C08K 7/28; C08J 2315/00; C08K 2201/003

(57) ABSTRACT

Provided are methods of fabricating flexible syntactic foam objects from precursor powders comprising thermoplastic elastomer particles and hollow particles using selective laser sintering (SLS) with a porous/discontinuous internal structure. The method may comprise illuminating a region in a layer of a precursor powder comprising thermoplastic elastomer particles and hollow particles with a laser beam of a SLS to convert the region to a porous, sintered region comprising the hollow particles and a solid thermoplastic elastomer matrix having a surface that defines pores distributed throughout the porous, sintered region. The syntactic foam objects and articles of manufacture comprising the syntactic foam objects are also provided.

### CROSS REFERENCE TO RELATED APPLICATIONS

The present application claims priority to U.S. provisional patent application No. 63/485,038 that was filed Feb. 15, 2023, the entire contents of which are incorporated herein by reference.

### REFERENCE TO GOVERNMENT RIGHTS

This invention was made with government support under N00014-19-1-2206 awarded by the NAVY/ONR. The government has certain rights in the invention.

### BACKGROUND

Composite materials are used in an extensive range of applications in the aerospace, automotive, marine, and defense industries because of their enhanced specific mechanical properties and functionality. One category of composite materials includes syntactic foams formed from hollow, thin-walled particles blended within continuous polymeric, metallic, or ceramic matrices. A variety of techniques have been used to manufacture such syntactic foams, including injection molding, compression molding, and some additive manufacturing techniques.

### SUMMARY

Provided are methods of fabricating syntactic foam objects from precursor powders comprising thermoplastic elastomer particles (e.g., thermoplastic polyurethane (TPU) particles) and hollow particles (e.g., glass microbubbles (GMBs)). The methods make use of selective laser sintering (SLS) to sinter regions of the precursor powder from which the syntactic foam objects are composed. The present methods are carried out to ensure the formation of pores within the sintered regions. The present methods are further based on a number of unexpected findings, including that the physical characteristics of the hollow particles (e.g., their sizes) affect the structure of the sintered regions as well as the nature of hollow particle incorporation within the sintered regions. These findings have been leveraged to achieve control over the fabrication of syntactic foam objects having a broad range of mechanical properties.

In embodiments, a method of fabricating a syntactic foam object comprises illuminating a region in a layer of a precursor powder comprising thermoplastic elastomer particles and hollow particles with a laser beam of a selective laser sintering system (SLS) to convert the region to a porous, sintered region comprising the hollow particles and a solid thermoplastic elastomer matrix having a surface that defines pores distributed throughout the porous, sintered region.

In embodiments, a syntactic foam object comprises a porous, sintered region formed by illuminating a region in a layer of a precursor powder comprising thermoplastic elastomer particles and hollow particles with a laser beam of a selective laser sintering system (SLS), wherein the porous, sintered region comprises the hollow particles and a solid thermoplastic elastomer matrix having a surface that defines pores distributed throughout the porous, sintered region.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1 summarizes the experiments conducted in the Example, below.

FIGS. 2A-2B show plots of the particle size distribution of (FIG. 2A) pure thermoplastic polyurethane (TPU) powder and (FIG. 2B) three grades of glass microbubbles (GMBs), GM60, GM22, and GM15.

FIGS. 3A-3C show scanning electron microscope (SEM) images of precursor powders consisting of TPU particles and GMBs, including (FIG. 3A) TPU/GM60-20, (FIG. 3B) TPU/GM22-20, and (FIG. 3C) TPU/GM15-20. (E.H.T.=3 kV and Signal=SE2)

FIG. 4 shows differential scanning calorimetry (DSC) curves for TPU powder and the three precursor powders, TPU/GM60-20, TPU/GM60-40, and TPU/GM60-60. The results show the effect of the addition of GMBs on the sintering window for the powder blends.

FIG. 5, panels (a)-(l) show SEM images (E.H.T.=3 kV and Signal=SE2) of pure TPU foams printed with different Laser Power Ratio (LPR) and Layer Height (LH) combinations as follows: (FIG. 5, panel (a)) Layer Height=75 μm Laser Power Ratio=0.75; (FIG. 5, panel (b)) Layer Height=75 μm Laser Power Ratio=1.0; (FIG. 5, panel (c)) Layer Height=75 μm Laser Power Ratio=1.5; (FIG. 5, panel (d)) Layer Height=75 μm Laser Power Ratio=2.0; (FIG. 5, panel (e)) Layer Height=125 μm and Laser Power Ratio=0.75; (FIG. 5, panel (f)) Layer Height=125 μm and Laser Power Ratio=1.0 (Default); (FIG. 5, panel (g)) Layer Height=125 μm and Laser Power Ratio=1.5; (FIG. 5, panel (h)) Layer Height=125 μm and Laser Power Ratio=2.0; (FIG. 5, panel (i)) Layer Height=175 μm and Laser Power Ratio=0.75; (FIG. 5, panel (j)) Layer Height=175 μm and Laser Power Ratio=1.0; (FIG. 5, panel (k)) Layer Height=175 μm and Laser Power Ratio=1.5; and (FIG. 5, panel (l)) Layer Height=175 μm and Laser Power Ratio=2.0.

FIG. 6, panels (a)-(f) show SEM images (E.H.T.=3 kV and Signal=SE2) of syntactic foams printed with final print parameters (Laser Power Ratio=1.5 and Layer Height=75 μm) containing 20% volume fraction of GMBs for (FIG. 6, panel (a)) SF60-20; (FIG. 6, panel (b)) SF22-20; and (FIG. 6, panel (c)) SF15-20; and SEM images of syntactic foams printed with the modified print parameters (Laser Power Ratio=2.0 and Layer Height=75 μm) containing 20% volume fraction of GMBs for (FIG. 6, panel (d)) SF60-20; (FIG. 6, panel (e)) SF22-20; and (f) SF15-20.

FIGS. 7A-7B show Fourier Transform Infrared (FTIR) curves for (FIG. 7A) TPU powder and the 3D printed pure TPU foam and (FIG. 7B) TPU foam and SF60-20 syntactic foam printed with same parameters.

FIGS. 8A-8B show (FIG. 8A) tensile stress-strain plots for pure TPU foams with changing laser power ratio and a fixed layer height (layer height was varied for the selected laser power) and (FIG. 8B) a summary of the tensile properties with varying print parameters.

FIGS. 9A-9B show (FIG. 9A) tensile stress-strain plots for syntactic foams with changing GMB volume fraction (for volume fraction 60%, a laser power ratio of 2.0 was also used) and (FIG. 9B) tensile stress strain plots for syntactic foams with varying grades of GMBs with fixed volume fraction=20%.

FIGS. 10A-10D show typical compressive stress-strain behavior of (FIG. 10A) pure TPU foams and (FIG. 10B) syntactic foams, and corresponding schematic illustrations of the compression mechanics for (FIG. 10C) pure TPU foams and (FIG. 10D) syntactic foams.

FIGS. 11A-11B show (FIG. 11A) compressive stress-strain plots for SF60 syntactic foams with changing GMB volume fraction and (FIG. 11B) compressive stress strain plots for syntactic foams with varying grades of GMBs with fixed volume fraction=20%.

FIGS. 12A-12B summarize (FIG. 12A) the compressive properties and (FIG. 12B) the normalized compressive properties, for different GMB types with varying GMB content (volume fraction).

FIGS. 13A-13D show compressive stress-strain curves for (FIG. 13A) TPU foam, (FIG. 13B) SF60-20, (FIG. 13C) SF22-20, and (FIG. 13D) SF15-20 syntactic foam under repeated loading. Samples are compressed twice until mentioned strain values with a gap of 1 week between the loading cycles.

FIGS. 14A-14C show SEM images of (FIG. 14A) SF60-20, (FIG. 14B) SF22-20, and (FIG. 14C) SF15-20 syntactic foams compressed twice to 50% strain with a gap of 1 week between both loading cycles.

FIG. 15 illustrates a structural—process—property map (calibration plot) to aid with designing and manufacturing syntactic foams with segregated matrix using Selective Laser Sintering.

FIG. 16A shows images of printed architected SF60-40 syntactic foam samples. FIG. 16B shows images of additional printed architected SF60-40 syntactic foam samples: the left image shows a shoe sole and the right image shows block structures sandwiched between stiff top and bottom material sheets.

FIG. 17 illustrates the effect of laser power and scanning speed on the energy melt pool.

### DETAILED DESCRIPTION

Provided are methods of fabricating syntactic foam objects. In embodiments, such a method comprises illuminating a region in a layer of a precursor powder comprising (or consisting of) thermoplastic elastomer particles and hollow particles with a laser beam of a selective laser sintering system (SLS). The illumination is carried out under conditions, e.g., SLS parameters, that convert the region in the layer of the precursor powder to a porous, sintered region. This porous, sintered region comprises a solid thermoplastic elastomer matrix extending throughout a volume defined by the laser beam and having a surface that defines pores distributed throughout the matrix, and thus, the porous, sintered region. During the illumination, the laser melts and fuses thermoplastic particles together and the conditions being used ensure that pores, i.e., voids, are defined within the solid thermoplastic elastomer matrix. Solid thermoplastic elastomer matrices formed under such conditions may be referred to herein as “segregated matrices.” The conditions used in the present methods are by contrast to those that form continuous (i.e., substantially non-porous) solid thermoplastic elastomer matrices. After the illumination, the hollow particles provided by the precursor powder are also present within the porous, sintered region. However, the particular positioning of the hollow particles, i.e., the positioning of the hollow particles relative to the solid thermoplastic elastomer matrix and to its pores, is tunable, a feature of the present methods described in greater detail below.

The porous, sintered region formed within the layer of the precursor powder may assume various shapes and dimensions which are achievable, e.g., by scanning the laser beam across the layer according to digital data (e.g., CAD model) corresponding to a desired syntactic foam object. Such digital data may be accessed by a controller of the SLS system operably coupled to the laser beam. Additional exposure steps may be carried out on additional layers of the precursor powder to form the desired syntactic foam object in a layer-by-layer fashion, the shape and dimensions of which may also be determined by the digital data.

The thermoplastic elastomer particles of the precursor powder refer to individual, discrete solid particles composed of a thermoplastic elastomer. A variety of types of thermoplastic elastomers may be used, provided the thermoplastic elastomer is one capable of being fabricated into an object via SLS. Otherwise, selection of the thermoplastic elastomer depends upon the desired application for the fabricated syntactic foam object. Illustrative thermoplastic elastomers include thermoplastic polyurethanes (TPUs), thermoplastic polyamide elastomer (TPE-A), and thermoplastic copolyester elastomer (TPE-E). The thermoplastic elastomer particles in the precursor powder may include those of a single type of thermoplastic elastomer or multiple, different types of thermoplastic elastomers.

The hollow particles of the precursor powder are generally spherical structures having relatively thin walls which define a void therein. Hollow particles composed of a variety of types of materials may be used, depending upon the desired application for the fabricated syntactic foam object. Illustrative hollow particles include glass microballoons (GMBs), cenospheres, and metal-coated ceramic particles. The hollow particles in the precursor powder may include those of a single type of material or multiple, different types of materials.

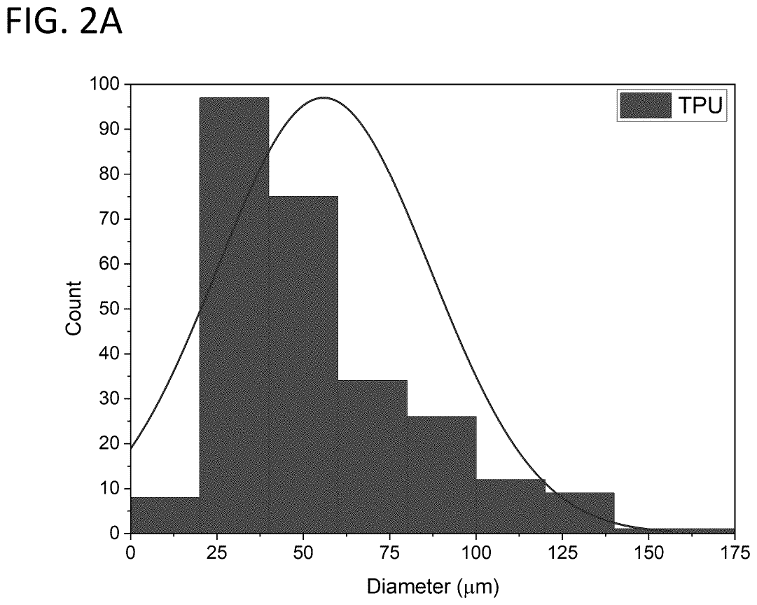

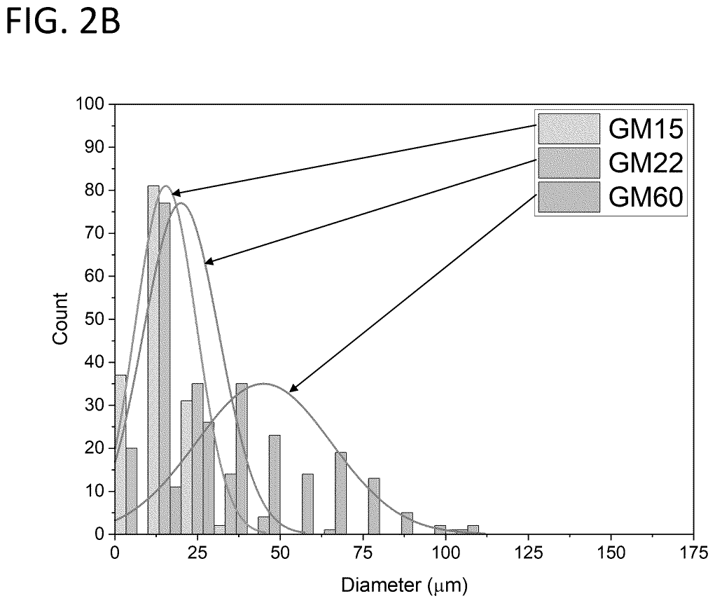

The hollow particles in the precursor powder may be characterized by their size. The size of a collection of hollow particles may be reported as a D₅₀ particle size, which refers to a diameter at which 50% of the hollow particles (on a volume basis) are comprised of hollow particles having a diameter less than said diameter value. The size of an individual hollow particle refers to its diameter. A collection of hollow particles may be further characterized by the distribution of sizes of individual hollow particles therein. These characteristics are illustrated in FIG. 2B showing the size distribution for three grades of GMBs, GM15 (D₅₀ particle size—15 μm), GM22 (D₅₀ particle size—22 μm), and GM60 (D₅₀ particle size—60 μm). Selection of hollow particle parameters, i.e., D₅₀ particle sizes, size distributions, and volume fractions, to be used in the precursor powder is further described below. By “volume fraction” it is meant a total volume of hollow particles in the precursor powder as compared to a total volume of the precursor powder.

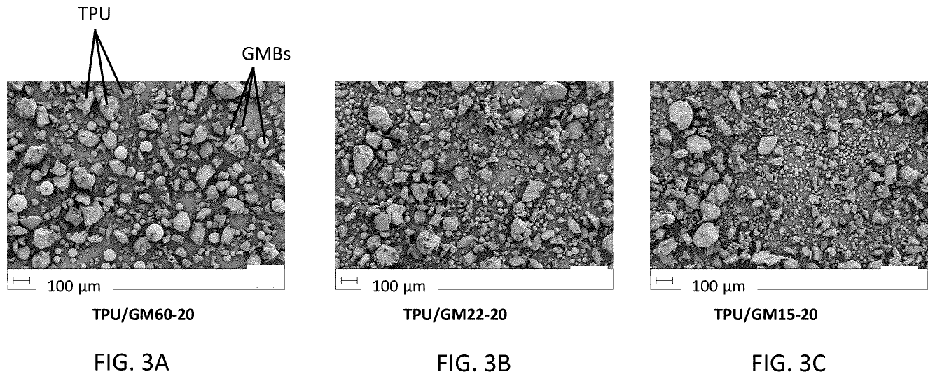

FIGS. 3A-3C show scanning electron microscope (SEM) images of three illustrative precursor powders comprising TPU particles as the thermoplastic elastomer particles and GMBs as the hollow particles. Each precursor powder comprised the same volume fraction (20%) of GMBs, but a different grade (D₅₀ particle size) of GMBs, including GM60 (FIG. 3A), GM22 (FIG. 3B), and GM15 (FIG. 3C). Some GMBs (spherical in shape) and TPU particles (more irregularly shaped) are labeled in FIG. 3A. Although other additives may be included in the precursor powders, in embodiments, such as those shown in FIGS. 3A-3C, the precursor powders consist of the thermoplastic elastomer particles and the hollow particles.

As noted above, the present methods are carried out using an SLS system, the type of which is not particularly limited. A variety of commercially available SLS systems may be used. The SLS parameters used during the methods include, e.g., a sintering window (temperature of the precursor powder), an energy density of the laser beam (as determined by a laser power ratio (LPR)), and a layer height (dimension of the layer of the precursor powder as measured perpendicular to plane defined by the layer). Regarding LPR, this SLS parameter is determined by the laser beam power and the laser scanning speed (or illumination time) of the laser beam being used. The SLS parameters are selected to ensure formation of the pores within the solid thermoplastic elastomer matrix as described above. The particular values of the SLS parameters that achieve this depend, at least in part, upon the SLS system as well as the type of thermoplastic elastomer particles being used.

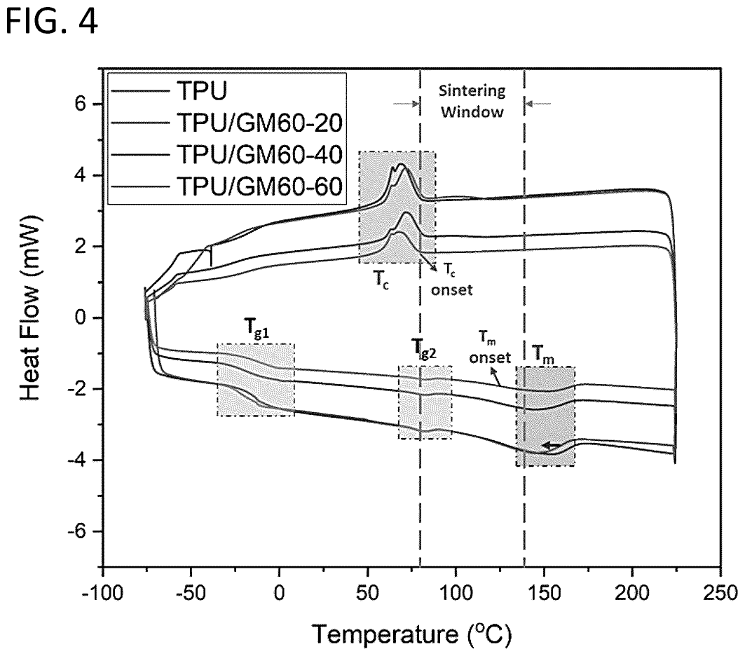

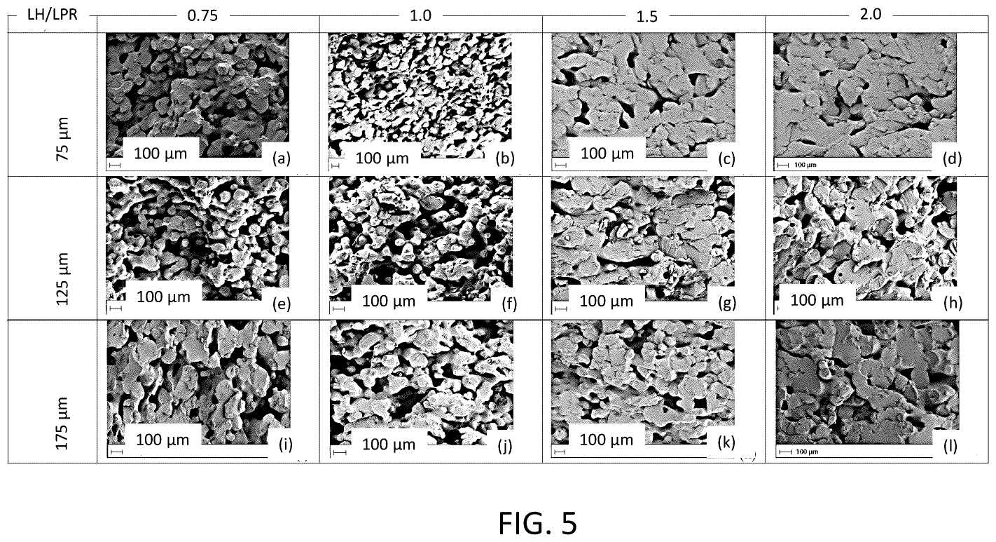

Illustrative SLS parameters which achieve porous, sintered regions are provided in the Example, below. FIG. 5, panels (a)-(l) show SEM images of porous, sintered regions formed within layers of a powder consisting of TPU particles (no hollow particles were used). The SLS parameters included a sintering window as determined from FIG. 4; an LPR of 0.75, 1, 1.5, and 2; and a layer height of from 75 μm, 125 μm, and 175 μm. By changing the LPR while holding laser beam power constant at 5 W, the laser scanning speed was effectively varied from 83 mm/s, to 56 mm/s, to 37 mm/s, and to 28 mm/s, respectively. These images illustrate the sintering/fusion of individual, discrete TPU particles into an interconnected, solid thermoplastic elastomer matrix, the surface of which defines pores distributed throughout the matrix. These images also show that the pores are generally irregularly shaped. Some such pores have a shape that can still be generally approximated by a sphere while other pores have a more elongated shape, including those in the form of tortuous channels. These images further illustrate that the thickness of the solid thermoplastic elastomer matrix between pores (which may be referred to herein as a “cell wall thickness”) depends upon the particular SLS parameters being used. Since pore sizes and porosity are related to cell wall thickness, these characteristics also depend upon the SLS parameters being used. For example, FIG. 5, panels (a)-(l) show that increasing the LPR from 0.75 to 2.0 generally increases the cell wall thickness and decreases pore sizes/porosity. However, for higher LPR values of 1.5 and 2.0, it was also observed that the cell wall thickness increased with decreasing layer height. This is attributed to the repeated sintering of more layers due to smaller layer heights. The results show that the SLS parameters may be further selected to achieve a desired cell wall thickness/pore sizes/porosity, together which affect the mechanical properties of the fabricated syntactic foam object.

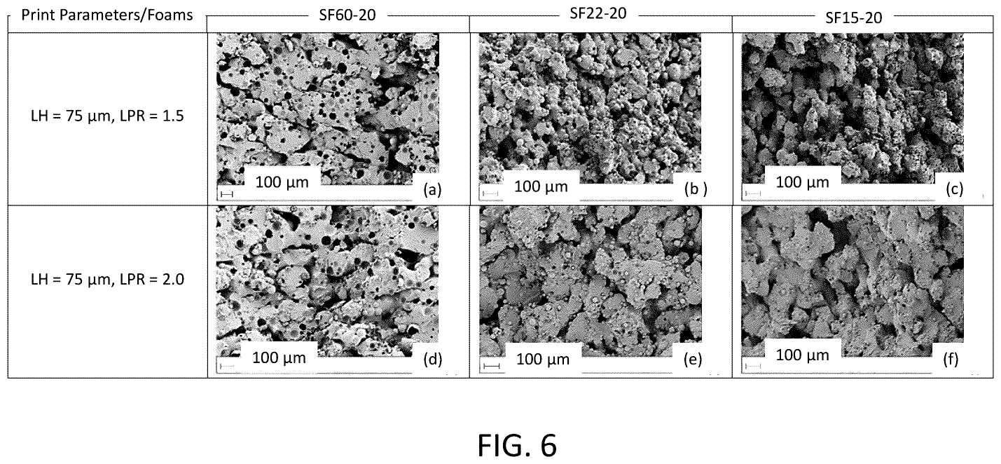

In addition to the SLS parameters, it has been unexpectedly found that hollow particle parameters also affect the structure of the solid thermoplastic elastomer matrix, i.e., cell wall thickness/pore sizes/porosity. For example, the diameters of the hollow particles in the precursor powder have been found to affect cell wall thickness/pore sizes/porosity of the solid thermoplastic elastomer matrix. This is illustrated in FIG. 6, panels (a)-(c) and described in detail in the Example, below. Briefly, these figures show SEM images of porous, sintered regions formed within layers of three illustrative precursor powders, each consisting of TPU particles and GMBs. Each precursor powder was illuminated using the same SLS parameters and comprised the same volume fraction (20%) of GMBs, but comprised a different grade (different D₅₀ particle size and size distribution) of GMBs: GM60 (FIG. 6, panel (a)), GM22 (FIG. 6, panel (b)), and GM15 (FIG. 6, panel (c)). The images illustrate that increasing D₅₀ particle size of the hollow particles increases cell wall thicknesses (decreases pore sizes/porosity).

The volume fraction of the hollow particles in the precursor powder has also been found to affect cell wall thickness/pore sizes/porosity of the solid thermoplastic elastomer matrix. Briefly, other experiments analogous to those described above with respect to FIG. 6 and described in detail in the Example, below, establish that increasing the volume fraction of the hollow particles decreases cell wall thicknesses (increases pore sizes/porosity).

These unexpected findings reveal that hollow particle parameters may also be selected (and coupled with SLS parameters) to achieve a desired cell wall thickness/pore size/porosity, and thus, fabricated syntactic foam objects having desired mechanical properties. Illustrative values of hollow particle parameters that may be used are provided in the Example, below.

As further described in the Example, below, FIG. 6, panels (a)-(c) reveal an additional unexpected finding that the positioning of the hollow particles relative to the solid thermoplastic elastomer matrix and to its pores depends upon the hollow particle parameters and the SLS parameters and thus, is tunable. Specifically, hollow particles having sizes smaller than the sizes of pores defined by the solid thermoplastic elastomer matrix tend to become incorporated within the solid thermoplastic elastomer matrix. Such hollow particles may be referred to herein as “embedded hollow particles.” By “embedded” it is meant that the entire surface area of an embedded hollow particle is surrounded by and in contact with the solid thermoplastic elastomer matrix.

By contrast, hollow particles having sizes larger than the sizes of pores defined by the solid thermoplastic elastomer matrix tend to be excluded from the solid thermoplastic elastomer matrix and instead, become incorporated into the pores defined by the matrix. Such hollow particles may be referred to herein as “protruding hollow particles.” By “protruding” it is meant that the hollow particle protrudes out of the surface of the solid thermoplastic elastomer matrix and into a pore defined by that surface. The amount of surface area extending into a pore may vary, but as protruding hollow particles are distinguished from embedded hollow particles, at least some surface area of a protruding hollow particles is not surrounded by and is not in contact with the solid thermoplastic elastomer matrix. Protruding hollow particles include those which span across pores to form a “bridge” connecting opposing surfaces of the solid thermoplastic elastomeric matrix.

Referring back to FIG. 6, panels (a)-(c), as noted above, these SEM images show porous, sintered regions formed from precursor powders having different grades (different D₅₀ particle sizes and size distributions) of GMBs: GM60 (FIG. 6, panel (a)), GM22 (FIG. 6, panel (b)), and GM15 (FIG. 6, panel (c)). Thus, the GM60 hollow particles (FIG. 6, panel (a)) comprise a greater amount of larger diameter hollow particles as compared to the GM22 (FIG. 6, panel (b)) and the GM15 (FIG. 6, panel (c)) hollow particles. (See FIG. 2B.) This results in the porous, sintered region of FIG. 6, panel (a) having smaller sized pores (as described above) and a greater amount of the hollow particles being incorporated as protruding hollow particles as compared to the porous, sintered regions of FIG. 6, panels (b)-(c). However, as the size distribution of the GM60 hollow particles is fairly broad, the porous, sintered region of FIG. 6, panel (a) also comprises some embedded hollow particles. By contrast, the porous, sintered regions of FIG. 6, panels (b)-(c) each have larger sized pores (as described above) and a greater amount of the hollow particles being incorporated as embedded hollow particles. The porous, sintered region of FIG. 6, panel (c), formed using the smallest diameter hollow particles with the narrowest size distribution, comprises the greatest amount of embedded hollow particles. Together, these results show that the D₅₀ particle sizes and size distributions of the hollow particles being used may be selected to tune the positioning of the hollow particles within the solid thermoplastic elastomer matrix. This can include using more than one grade of hollow particles in the precursor powder, e.g., hollow particles having relatively small D₅₀ particle sizes (to provide embedded hollow particles) and hollow particles having relatively large D₅₀ particle sizes (to provide protruding hollow particles).

Similarly, as shown in FIG. 6, panels (d)-(f), the SLS parameters may also be adjusted to tune the positioning of the hollow particles within the solid thermoplastic elastomer matrix, since these also control pore size. These images show porous, sintered regions formed using the same precursor powders used in FIG. 6, panels (a)-(c), respectively, except that a higher LPR value was used. The higher LPR value results in smaller sized pores, driving a greater amount of the hollow particles to become incorporated as protruding hollow particles in FIG. 6, panels (d)-(f) to panels (a)-(c), respectively.

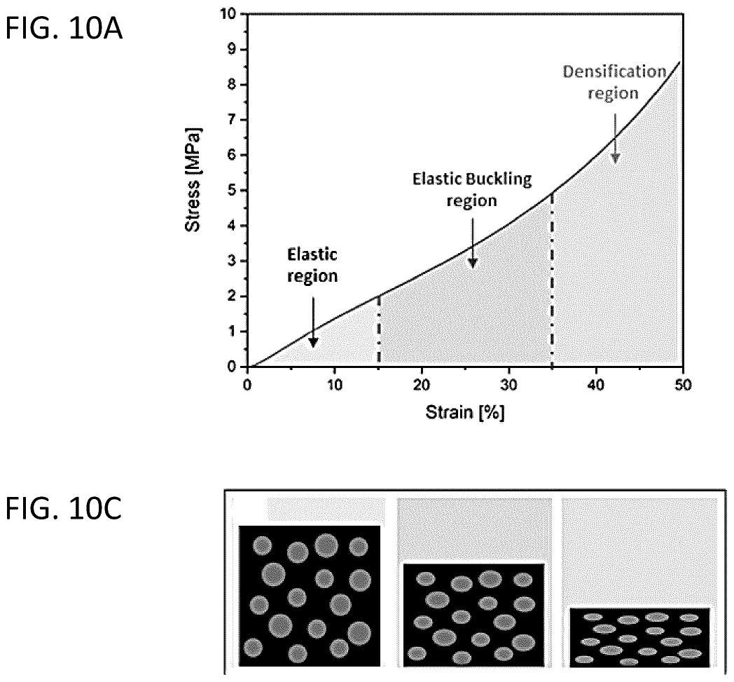

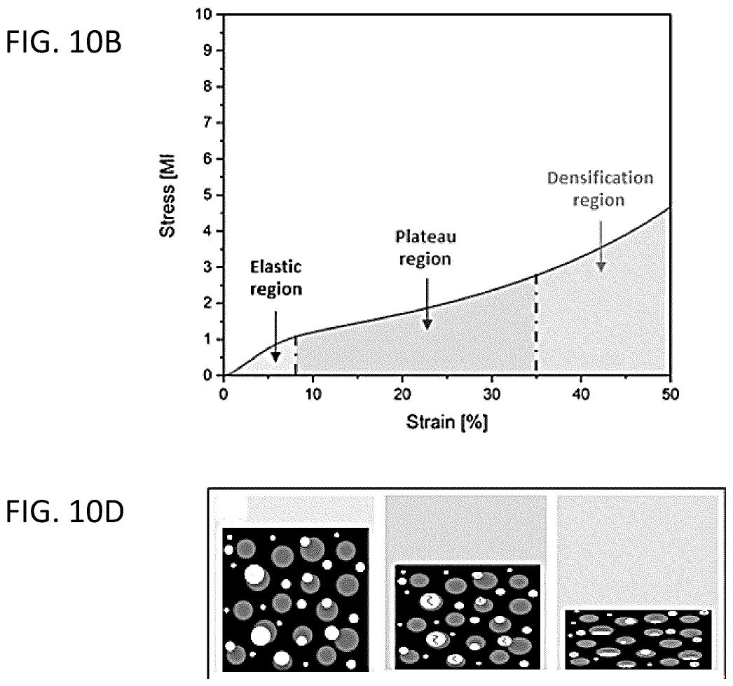

As shown in FIGS. 10B, 11A-11B and 12A-12B, and further described in the Example, below, the two different types of hollow particle incorporation, i.e., protruding hollow particles versus embedded hollow particles, have been found to have unexpected effects on the mechanical properties, especially the compressive modulus (stiffness) and densification stress (strength), of fabricated syntactic foam objects. Specifically, larger protruding hollow particles provide such objects with an increased stiffness (compressive modulus) and decreased densification stress (compressive strength). By contrast, smaller embedded hollow particles result in syntactic foam objects with compressive properties more comparable to those of the solid thermoplastic elastomer matrix itself, but with significant weight reduction.

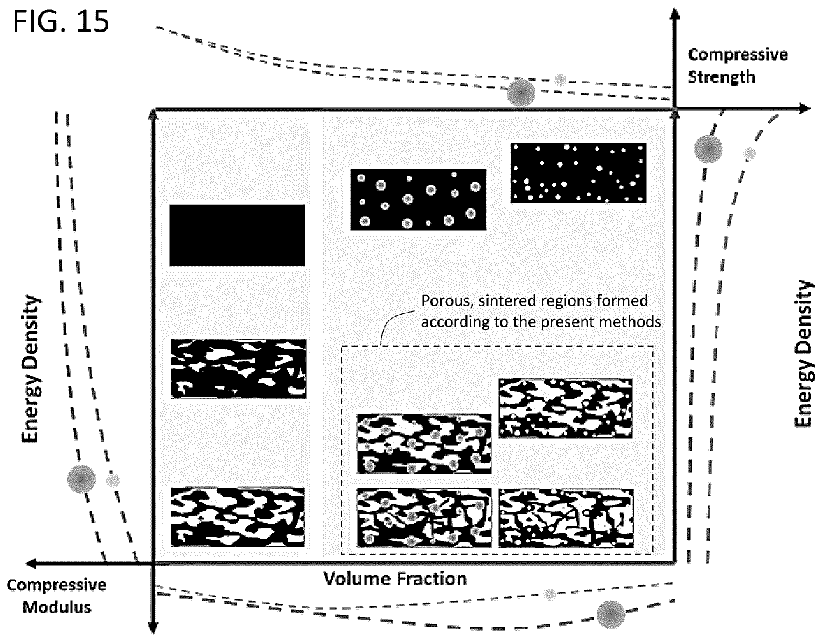

The inventors' discovery of additional parameters (i.e., hollow particle parameters) and subsequent understanding how to couple these to SLS parameters affords the present methods greater control over the fabrication of syntactic foam objects having a broad range of mechanical properties. Such control may be implemented by using calibration plots, such as that shown in FIG. 15 and further described in the Example, below. This calibration plot illustrates the relationship between a key SLS parameter (energy density), key hollow particle parameters (diameter and volume fraction), the structure of the porous, sintered regions (schematic images within the plot labeled in a dashed box), and the compressive properties of the porous, sintered regions (compressive strength and compressive modulus). For comparison, five comparative schematic images are shown, corresponding to three sintered regions (left) formed from powders with only thermoplastic elastomer particles (no hollow particles) and two sintered regions (top middle and right) formed using conditions that achieve a continuous, nonporous solid thermoplastic elastomer matrix.

FIG. 15 illustrates and summarizes the findings described above and further described in the Example, below. For example, the four schematic images of porous, sintered regions illustrate the finding that hollow particle diameter affects the structure of the solid thermoplastic elastomer matrix and the nature of the hollow particle incorporation. Specifically, larger diameters result in increased cell wall thickness and decreased pore size/porosity, driving the formation of protruding hollow particles. Smaller diameters result in decreased cell wall thickness and increased pore size/porosity, driving the formation of embedded hollow particles.

FIG. 15 also illustrates the effect of hollow particle diameter, hollow particle volume fraction, and energy density on the compressive properties of the porous, sintered regions. With reference to the vertical axes of the calibration plot, at a particular hollow particle volume fraction, larger diameters result in a greater compressive modulus (and lower compressive strength) as compared to smaller diameters. However, compressive modulus and compressive strength may be increased by increasing energy density. With reference to the horizontal axes of the calibration plot, at a particular energy density, again, larger diameters result in a greater compressive modulus (and lower compressive strength) as compared to smaller diameters. However, a volume fraction exists at which the compressive modulus may be maximized for both large and small diameters. The volume fraction corresponding to the peak compressive modulus is lower for smaller diameters as compared to larger diameters.

Calibration plots such as that shown in FIG. 15 may be generated from experiments similar to those described in the Example below, using a particular SLS system, particular thermoplastic elastomer particles, and particular hollow particles. The calibration plots are not limited to those correlating SLS and hollow particle parameters to compressive properties; similar calibration plots may be generated for tensile properties. Any such calibration plots may be used in the fabrication of syntactic foam objects to achieve desired mechanical properties. For example, for a particular energy density, the calibration plot(s) may be used to determine the appropriate selection of hollow particle D₅₀ particle sizes and/or volume fractions to achieve a desired compressive strength and/or compressive modulus. As another example, for a particular hollow particle D₅₀ particle size, the calibration plot(s) may be used to determine the appropriate selection of energy density and/or volume fraction, to achieve a desired compressive strength and/or compressive modulus. The calibration plots may be stored and accessed by a controller of the SLS system being used to carry out the present methods.

Syntactic foam objects fabricated using the present methods are also encompassed. A syntactic foam object may comprise (or consist of) a porous, sintered region formed by illuminating a region in a layer of a precursor powder comprising (or consisting of) thermoplastic elastomer particles and hollow particles with a laser beam of a selective laser sintering system (SLS), wherein the porous, sintered region comprises (or consists of) the hollow particles and a solid thermoplastic elastomer matrix having a surface that defines pores distributed throughout the porous, sintered region.

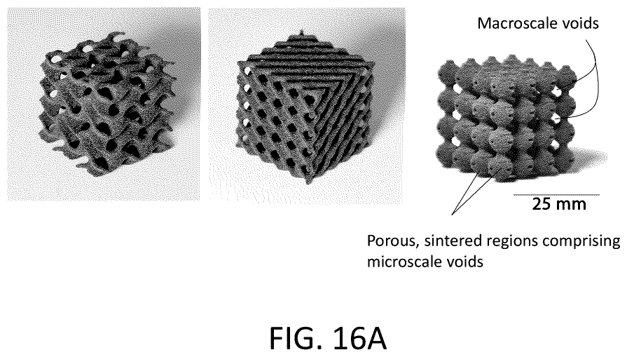

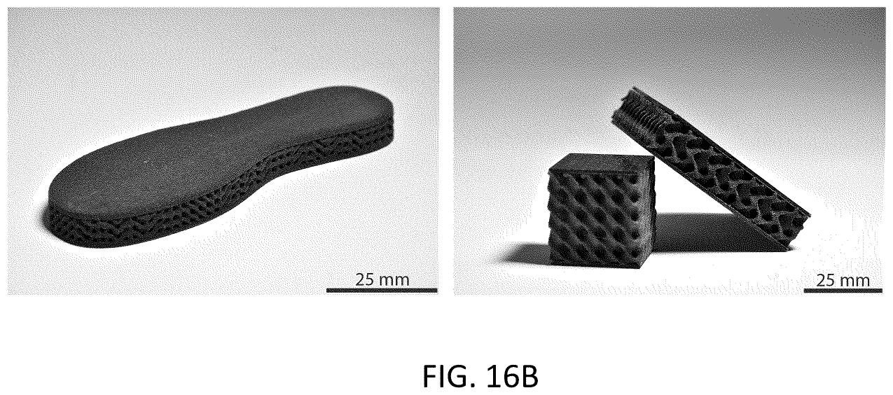

As noted above, the syntactic foam objects are generally fabricated by forming porous, sintered regions within sequential layers of precursor powders such that the collection of layered porous, sintered regions corresponds to the syntactic foam object. As also noted above, the shape and dimensions of syntactic foam objects are not particularly limited, but rather depend upon the desired application. A simple illustrative shape is a block. However, FIG. 16 shows that the SLS technique enables even blocks to assume a variety of complex and intricate internal architectures. Each syntactic foam object was fabricated using the present methods. The outer shape of each syntactic foam object is that of a block, but the porous, sintered regions formed in each precursor powder layer were patterned so as to provide voids within the blocks having various shapes and dimensions. These voids are generally larger and are otherwise distinguished from the voids within the porous, sintered regions themselves. As labeled in FIG. 16A, the voids formed by patterning the layer of the precursor powder (e.g., by scanning the laser beam according to a particular pattern) may be referred to as “macroscale voids” while the voids formed within the porous, sintered regions may be referred to as “microscale voids.”

Regarding the porous, sintered regions from which the present syntactic foam objects are composed, as described above, these regions comprise (or consist of) a solid thermoplastic elastomer matrix having a surface that defines pores distributed throughout the matrix; and hollow particles distributed throughout the regions. Any of the thermoplastic elastomer particles and hollow particles described herein may be used. The hollow particles may be incorporated as embedded hollow particles, protruding hollow particles, or both embedded and protruding hollow particles may be present. As described herein, the porosities of the regions as well as the relative amounts of embedded hollow particles and protruding hollow particles in the regions may be tuned to achieve desired mechanical properties by appropriate selection of SLS parameters and hollow particle parameters (illustrative values of which have been described herein).

Regarding porosities, porosity values may be determined using a helium porosimeter as described in the Example, below. These porosity values refer to the porosity provided by the microscale voids described above, i.e., the voids formed in the solid thermoplastic elastomer matrix via sintering/fusion, as opposed to macroscale voids and as opposed to voids defined inside the hollow particles. In embodiments, the porous, sintered regions from which the present syntactic foam objects are composed have a porosity value in a range of from 20% to 40%. This includes from 25% to 35% and from 27% to 33%. These values may be referenced to a particular type of thermoplastic elastomer (e.g., TPU), a particular type of hollow particles (e.g., GMBs), a particular volume fraction of hollow particles (e.g., 20%), and a particular set of SLS parameters. By way of illustration, the Examples below achieved porosities of from about 27% to about 33%.

Porosity values may also be indicative of the nature of the hollow particle incorporation. For example, for a particular set of SLS parameters and thermoplastic elastomer particles only (no hollow particles), the resulting solid thermoplastic elastomer matrix may be characterized by a base porosity value, which may be within the ranges described above. These values may be referenced to a particular type of thermoplastic elastomer (e.g., TPU) and a particular set of SLS parameters. By way of illustration, the Examples below achieved a base porosity value of about 28%. Using the same set of SLS parameters and the same thermoplastic elastomer particles, but also including hollow particles at a selected volume fraction, a porosity value greater than the base porosity value indicates that the hollow particles are incorporated as embedded hollow particles. By contrast, a porosity value that is about the same as or less than the base porosity value indicates that the hollow particles are incorporated as protruding hollow particles.

Since the SLS parameters may be different for different layers (or for different regions in an individual layer), in embodiments, different porous, sintered regions may have different porosities which is reflective of the relative amounts of embedded/protruding hollow particles therein. This may also be achieved by using different precursor powders for different layers. However, in other embodiments, all porous, sintered regions are characterized by the same porosities and the same relative amounts of embedded/protruding hollow particles.

Articles of manufacture comprising the syntactic foam objects are also encompassed. Such articles of manufacture include those in which conventional syntactic foams are used, including those used in the marine and aerospace industries. Illustrative articles of manufacture include helmets (e.g., the present syntactic foam objects may be used as liners in helmets) and footwear (e.g., the present syntactic foam objects may be used as soles of footwear, see FIG. 16B).

### Example

### Introduction

This Example elucidates how additive manufacturing parameters can be coupled with GMB parameters to achieve the desired mechanical response or to tune the mechanical response of syntactic foams having a segregated matrix. To that end, an SLS-based manufacturing method for producing multi-scale architected syntactic foams with segregated TPU matrix systems containing different grades of GMBs at varied volume fractions is presented. First, an experimental parametric study was conducted to determine the optimal print parameters for the production of syntactic foams. Then, the effects of the GMB characteristics on the mechanical response of these foams was determined by varying the volume fractions of various classes of GMBs with varying particle size distributions. In contrast to well-studied existing syntactic foams, this Example demonstrates for the first time that the particles themselves can be integrated in a variety of ways, influencing the mechanical response. Finally, architected syntactic foams were printed, and the impact of inclusion of GMBs on their compression response was examined.

### Experimental

This section describes the properties of the constituent materials used for manufacturing the syntactic foams, followed by details of the SLS process and different techniques used to characterize the constituent materials. Then, the mechanical test procedures performed in compliance with the ASTM standards are described.

### Materials

Thermoplastic polyurethane (TPU) powder was procured from Sinterit (Product Name: Flexa Grey; particle size between 20 and 120 μm) to manufacture the syntactic foams. 3M K20, 3M K46-HS, and 3M iM30k grades of GMBs were chosen to create powder blends consisting of TPU powder and different volume fractions of GMBs. The properties of the constituent materials are summarized in Table 1 and Table 2.

TABLE 1
Properties of TPU powder (Flexa Gray from Sinterit)

| | | Elongation | Shore | | | |
|---|---|---|---|---|---|---|
| Material | Tensile | at | Hard- | Melting | Softening | Granu- |
| Property | Strength | break | ness | Point | Point | lation |
| Value | 3.7 GPa | 136% | 70A | 160° C. | 67.6° C. | 20-105 μm |

TABLE 2
Properties of GMBs (*foam representation is given for volume fraction = 20%)

| | Test | True | Particle | Particle | Foam | GMB |
|---|---|---|---|---|---|---|
| Grade | Pressure | Density | size (D₅₀) | Representation | Representation | comments |
| 3M-K20 | 500 psi | 0.2 g/cc | 60 μm | GM60 | SF60-20 | Large |
| | | | | | | particles |
| 3M-K42HS | 7500 psi | 0.46 g/cc | 22 μm | GM22 | SF22-20 | Medium |
| | | | | | | particles |
| 3M-iM30k | 28000 psi | 0.60 g/cc | 15.3 μm | GM15 | SF15-20 | Small |
| | | | | | | particles |

### Manufacturing

This section discusses the manufacturing of pure TPU and GMB reinforced TPU syntactic foams using the SLS technique.

### SLS Printing

The syntactic foams were manufactured using a Lisa 3D printer from Sinterit, which is a desktop-based SLS printer equipped with an IR Laser diode of 5 W and a wavelength of 808 nm. In the SLS printing process, a roller pushes a layer of powder with a specified layer height, from the feed bed to the print bed. Then, the powder layer on the print bed is heated by the IR heaters to a temperature in the sintering window of the powder. Finally, a high-energy laser beam, with a prescribed energy density, fuses the powder to itself to form the provided 3D entity layer by layer. After the SLS printing process was complete, the samples were carefully removed and cleaned with a sandblaster—a brush was then used to remove any remaining particles from the surface.

Pure TPU powder (no GMB) and TPU/GMB blends with three different volume fractions of GMBs—20%, 40%, and 60% —were used to additively manufacture pure TPU and syntactic foams, respectively. For example, to prepare a mix with a 20% volume fraction of GMBs, 800 ml of TPU powder and 200 ml of GMBs were measured. The mixture was then loaded into a V-shaped mixer (Power=110 V and capacity=1.2 L), and the blend was first mixed at 30V for five minutes followed by mixing at 70V for another three minutes. The same mixing process was used for all volume fractions and GMB types.

### Effect of Laser Sintering Parameters

This section describes how the optimal parameters to sinter the polymer effectively were identified by varying the print parameters to understand their contributions to the morphology and the mechanical response of the printed foams.

### Laser Power Ratio

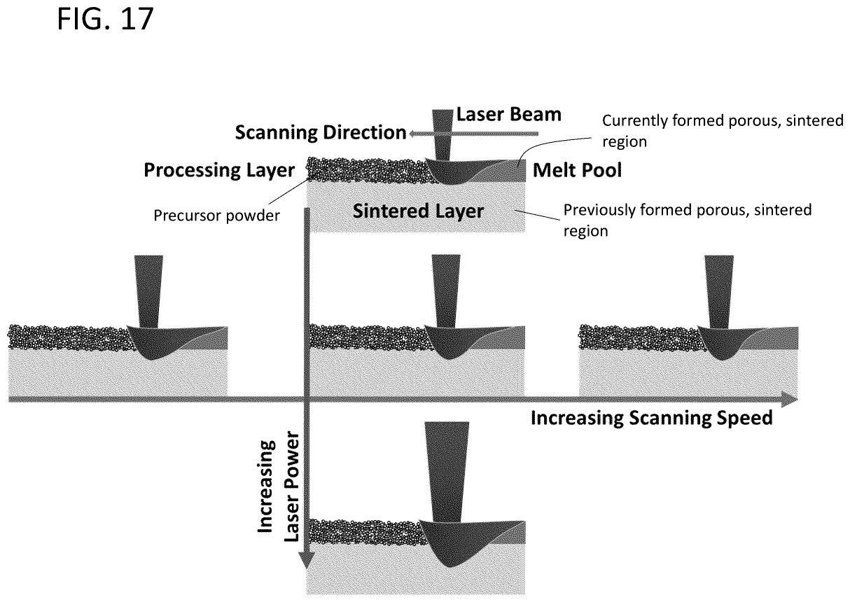

In the Sinterit Lisa printer, the laser power ratio is controlled by two parameters: i) laser power supplied and ii) scanning speed. The effective energy supplied to sinter the powder in the printer is affected by these two parameters. The laser power directly increases the energy density supplied to the polymer powder, which increases the depth of the melt pool, as illustrated in FIG. 17, whereas the energy density is inversely related to scanning speed. As the scanning speed increases, the dwell time decreases, which decreases the energy supplied, and vice versa. As a result, the laser power ratio corresponds to the effective energy density delivered to the system. In the Sinterit Lisa printer, the laser power is ideally fixed at 5 W, and therefore, to change the laser power ratio, the scanning speed is varied. When the laser power ratio is increased, it can potentially increase the proportion of the hard segment in the TPU that impacts the mechanical response—this will be discussed in further detail below.

### Layer Height

The height of each individual layer to be placed on the print bed for each sintering phase is referred to as the layer height parameter. Because SLS is a layer-based AM process, increasing layer height may result in a staircase effect, lowering print quality. Although a higher layer height can reduce print time, it can also intensify the staircase effect. Furthermore, given the same energy density, a higher layer height lowers the bonding between individual print layers, thus compromising mechanical performance. In this Example, the layer height was varied between 175 μm to 75 μm to see how it influences the mechanical response.

### Material Characterization

This section describes in-depth materials characterization performed to highlight the impact of print parameters and material compositions (for TPU/GMB blends) on the morphology, density, porosity, thermal properties, and potential degradation of the materials.

### Scanning Electron Microscopy (SEM)

Particle size distributions and microscale morphologies of TPU powder and GMBs were determined using the Zeiss Gemini 450 FESEM (3 keV and SE2 signal). A layer of powder was spread on a carbon tape and observed under the SEM and the diameter was measured using the ImageJ software. SEM was used to understand the microstructure of the printed specimens with different parameters and to analyze the morphologies of the specimens post failure.

### Fourier Transform Infrared (FTIR) Spectroscopy

The attenuated total reflectance FTIR spectroscopy on the Bruker FT-IR microscope was used to understand the chemical compositions of the constituents used to manufacture the syntactic foams. As the energy absorption ability of the powder is vital for the sintering process, the spectroscopic properties of the pure TPU powder and the TPU/GMB blends were also analyzed. Further, this technique was used to investigate the chemical changes due to the sintering process, and the effect of print parameters on the chemical composition of the printed foams was examined. The FTIR spectra of the syntactic foams were obtained at a resolution of 4 cm⁻¹ for wavenumbers ranging from 4000 cm⁻¹ to 600 cm⁻¹.

### Differential Scanning Calorimetry (DSC)

To evaluate the thermal properties of the TPU and determine the optimal sintering window, the TA Instruments QA 200 equipment was used. DSC allowed for the evaluation of the effect of incorporating GMBs on the thermal characteristics of the TPU/GMB blends. Approximately 8-10 mg of the sample was loaded into a Hermetic Aluminum pan, and it was rapidly heated to 225° C. at a rate of 20° C./min to get rid of any impurities present. The sample was then cooled to −70° C. at a constant rate of 10° C./min followed by heating to 225° C. at a rate of 10° C./min. DSC allowed for the identification of the melting temperature and the recrystallization temperature of the polymer powders, and the window between the onset of these two temperatures is the optimal sintering window. Nitrogen gas was used as a coolant, and the flow rate was maintained at 50 cm³/min. DSC curves were then evaluated using TA Universal Analysis Software.

### Porosity Measurements

A helium porosimeter was used to measure the porosity values of the pure TPU and TPU/GMB syntactic foams. The helium porosimeter consists of two cells, chamber and reference, with known internal volumes. The foam samples were placed inside the chamber cell for the measurements. After both cells were vacuumed until the pressure reached 0.3-0.4 psi, only the reference cell was loaded with helium gas until the pressure reached about 80-90 psi, and the pressure was recorded after it stabilized. Then the valve connecting the chamber and reference cells was opened to release the helium gas from the reference cell into the chamber cell. The resulting pressure was further recorded at equilibrium, and it was used to calculate the sample solid volume inside the chamber cell based on Boyle's law. Solid volume can be compared with the total sample volume to obtain porosity.

For all porosity tests, printed foams were used with dimensions of 25 mm×25 mm×25 mm and final print conditions. Individual porosity values of all pristine foams were obtained and compared with those of compressed foams to see the effect of compression loading. Two samples of each type of foam were chosen, and the porosity values were measured three times for each sample, with the average value chosen as the final porosity value.

### Mechanical Testing

### Tensile Testing

Uniaxial tensile tests of the printed foams were carried out in compliance with ASTM 638 (ASTM Standards—Standard Test Method for Tensile Properties of Plastics 1 2006, 03, 1) on the MTS universal testing instrument at the Structures and Materials Testing Laboratory at the University of Wisconsin Madison with a load cell capacity of 250 N. Type IV sample was chosen and loaded at a 50 mm/min cross-head speed. This cross-head speed was chosen such that the test completion time stayed between 1 to 5 minutes. Since TPU samples typically display failures at very high elongation, an Epsilon One optical extensometer was used to obtain the engineering strains. To understand their individual effect of print parameters on tensile performance, samples were printed with different laser power ratios and layer heights. In addition, samples with various GMB volume fractions produced using the finalized print parameters were examined under tensile stress.

### Compression Testing

Uniaxial compression tests were conducted on TPU foam samples on the ADMET 2613 tabletop frame equipped with a load cell capacity of 50 kN. The ASTM D1621 (ASTM Standards—Standard test method for compressive properties of rigid cellular plastics 1991, D 1621) standard for compression testing of plastics was used for these tests, and the sample size was chosen as 25 mm×25 mm×25 mm for the cube and all architected designs. Samples were loaded under uniaxial compression at a loading rate of 2.5 mm/min (10% of height per minute) to strain values of 20%, 30%, and 50%, and a preload of 1 N was used. The compressed samples were subjected to a second loading cycle one week after the initial loading cycle to examine the cyclic behavior under compression. All samples were loaded to 50% strain values for the second cycle.

### Results and Discussion

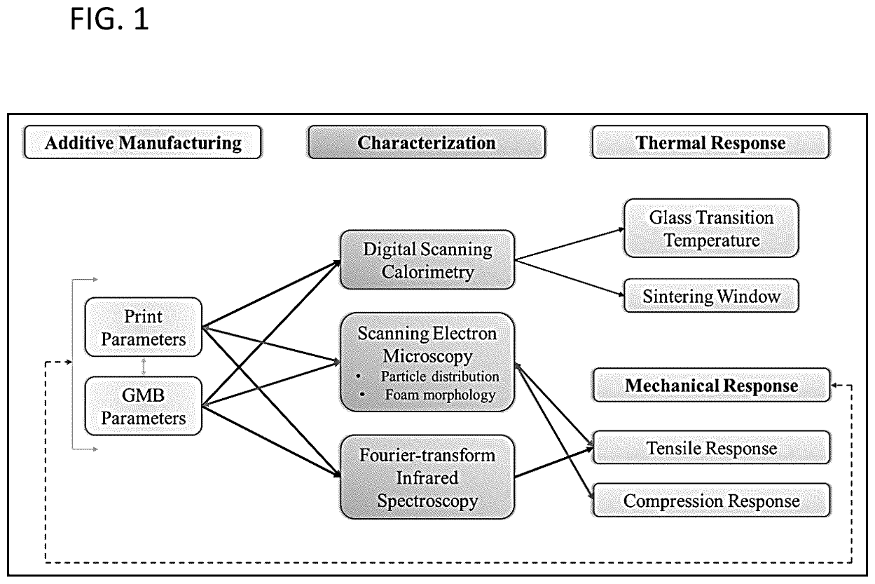

This section discusses the characterization results for the constituent powders followed by an evaluation of the printed foam morphology. In addition, the impact of the print settings and GMB parameters on the mechanical performance of the foams is discussed. Finally, the effect of GMB volume fraction and size on the mechanical response of these printed syntactic foams is elucidated. This experimental approach is summarized in FIG. 1.

### Characterization

SEM was employed to characterize the particle size distribution of the constituent powders and understand the distribution of the GMB inclusions in the powder blends. SEM images were also used to elucidate the effects of adding different GMBs on the morphology of the printed foams.

### Powder Size Distribution

The particle size distribution was obtained with the help of ImageJ, an image analysis software [64]. SEM images of the TPU powder and different GMBs were loaded in the ImageJ software and a measurement scale of 100 μm was used. Approximately 250 particles were measured using this measurement tool.

Particle size distributions are shown in FIGS. 2A-2B for the TPU powder and the three grades of GMBs chosen for this Example. FIG. 2A shows that the diameter of the TPU powder ranged from approximately 15 μm to 140 μm. FIG. 2B shows that the particle size for GM60 was in the range of 15 μm to 120 μm, which is a particle range similar to the TPU powder itself. However, for GM22 and GM15, the size distributions varied from 5 μm to 60 μm and 5 μm to 45 μm, respectively.

For any volume fractions of GMBs added to the TPU powder, the effective size distribution of the mix was between the distribution of TPU and the particular grade of GMBs.

FIGS. 3A-3C show the SEM images of TPU/GMB blends with the three sizes of GMBs mixed with a volume fraction of 20%. The polymer powder had an irregular shape, whereas all GMBs were perfectly spherical. Moreover, the smaller GMBs exhibited a higher GMB particle density per unit area than the larger GMBs. As the TPU powder and GMBs have distinct energy absorption characteristics, the GMB shape and distribution in the polymer blend had a substantial impact on the energy absorbed by the polymer powder in the mix. Smooth spherical shapes of the GMBs were create less hindrance in the path of the laser, and hence, the polymer blends absorbed more energy. However, this effect can be counteracted by the increased hindrance caused due a higher particle density as the particle size was reduced for a fixed volume fraction. Thus, as particle density increases, more energy density may be supplied to the system. For this Example, the supplied energy density was kept constant for all TPU/GMB blends.

### Thermoanalytical (DSC) Measurements

DSC measurements were performed to understand the impact of adding different volume fractions of GMBs to the TPU powder on the sintering window for the blend. The pure TPU powder and the corresponding GM60 blends were heated to 225° C. to understand the melting behavior. The samples were then cooled down to −70° C. for the crystallization behavior. The temperature difference between the melting and the crystallization onset points was obtained, which is a measure of the sintering window (as shown in FIG. 4). As the volume fraction of GM60 GMBs was increased from 0% to 60%, the sintering window reduced from 29.88° C. to 26.89° C. This can be attributed to the presence of GMBs in the powder blend which cannot get sintered, consequently reducing the sintering window for the mix. As TPU contains both hard and soft segments, two glass transition temperatures were observed in the DSC plot with two peaks for crystallization. Both glass transition temperatures, T_{g1} (for soft segments) and T_{g2} (for hard segments), stayed within the same temperature zone for the pure TPU powder and the other TPU/GM60 blends. The DSC observations are summarized in Table 3.

TABLE 3
Thermoanalytical measurements of powder blends with different volume
fractions of GM60 in the TPU powders.

| Powder Blend | Tg1 | Tg2 | Tₘ | T_{c} | ΔT (Tₘ-onset-T_{c} onset) |
|---|---|---|---|---|---|
| TPU | −16.96° C. | 62.70° C. | 143.21° C. | 68.27° C. | 29.88° C. |
| TPU/GM60-20 | −22.51° C. | 69.08° C. | 143.08° C. | 70.89° C. | 28.39° C. |
| TPU/GM60-40 | −19.53° C. | 61.82° C. | 142.08° C. | 71.26° C. | 27.36° C. |
| TPU/GM60-60 | −14.78° C. | 63.54° C. | 143.54° C. | 67.18° C. | 26.89° C. |

### Influence of Print and Foam Parameters on Microstructure

Pure TPU foams manufactured using the print parameters specified above were analyzed under SEM to observe the effect of these parameters on the microstructure of these foams. From FIG. 5, panels (a)-(l), it can be seen that the TPU foams manifested a porous structure with a segregated matrix. These foams got denser, and the cell wall thickness increased when the laser power ratio (LPR) was increased from 0.75 to 2.0. This is attributed to higher energy supplied to the system with increasing LPR, resulting in a larger cell wall thickness due to an increase in the melt pool size. For higher LPR values of 1.5 and 2.0, it was also observed that the cell wall thickness increased with decreasing layer height. This is attributed to the repeated sintering of more layers due to smaller layer heights.

To evaluate the effect of the size of the GMBs, foams with the final parameters chosen according to the details provided above were printed. From FIG. 6, panels (a)-(f), it was observed that bigger GMBs tended to lodge between cell walls as well as in the cell walls in SF60-20. However, in SF22-20 and SF15-20, having smaller GMBs, the GMBs tended to get lodged in the cell walls of the TPU foam due to the larger space between the cell walls than the particle size. The cell walls of the SF22-20 and SF15-20 foams were also thinner than those of the SF60-20 foams. As explained above, this drop in cell wall thickness is related to the decrease in energy absorbed by the TPU powder due to the presence of GMBs having a higher GMB particle per area density. In this Example, the energy delivered to all polymer blends remained constant so as to correlate the GMB parameters with the print parameters to evaluate the mechanical performance of the printed syntactic foams. However, a larger value of supplied energy density may be selected for smaller GMBs to achieve the same cell wall thickness for all blends. To show the effect of energy density on the morphology (cell wall thickness) of the TPU/GMB powder blends, SF60-20, SF22-20, and SF15-20 foams with a LPR of 2.0 and a layer height of 75 μm were printed. In FIG. 6, panels (d)-(f), the cell walls for the smaller particles appear thicker compared to foams shown in FIG. 6, panels (a)-(c). Therefore, the energy supplied to the system must be increased for the TPU/GMB powder blends to avoid reducing the cell wall thickness.

### FTIR Spectroscopic Analysis

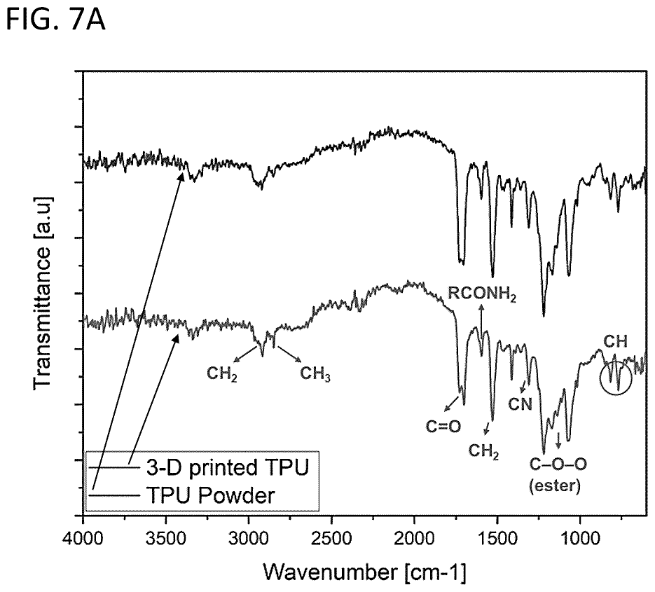

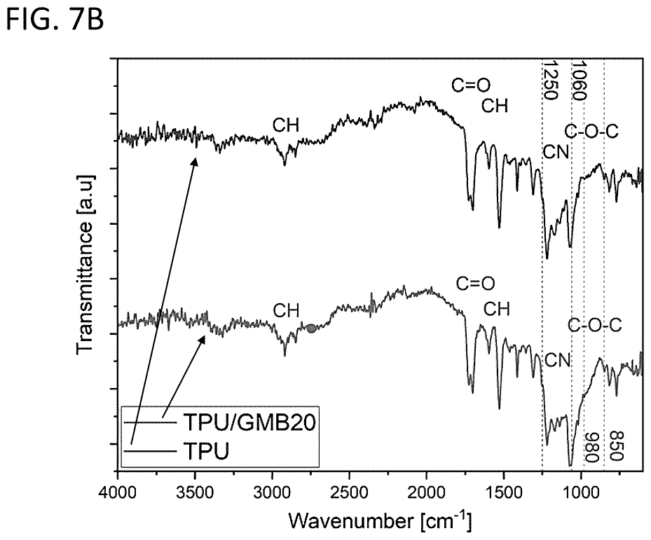

The chemical bonds within TPU and TPU/GMB foams were examined using FTIR. In this Example, a polyester based TPU was used, as can be seen from the FTIR spectroscopy graph shown in FIG. 7A, which shows the characteristic C=O group in the polyurethane and NH stretching vibrations at 1741 cm⁻¹ and 1540 cm⁻¹, respectively. Two strong absorption peaks were also seen at 2960 cm⁻¹ and 2823 cm⁻¹ which were attributed to the stretch vibrations of CH₂ and CH₃. When the laser power ratio was varied, effectively changing the supplied energy density to the powder, a shift in the band at 1722 cm⁻¹ was observed, which is assigned to the nonhydrogen-bonded carbonyl groups. When increasing the supplied energy density, the absorption intensity of the hydrogen-bonded C=O band (right of 1722 cm⁻¹) compared with the non-hydrogen bonded C=O band (left of 1722 cm⁻¹) increased, which is attributed to the increase in NCO:OH ratio. Therefore, it can be concluded that the number of hard segments increased by increasing the supplied energy density during the sintering process.

From the measured FTIR spectra of GMBs (FIG. 7B), sharp absorption peaks were observed at 980 cm⁻¹ and 850 cm⁻¹, which correspond to the Si—O—Si borosilicate material in GMBs. When TPU and GMBs were combined to manufacture a 3D printed part, FTIR was performed to see if there were any chemical changes due to the addition of these GMBs. Comparing the FTIR spectra of pure TPU and TPU/GMB foams, new peaks were only observed close to 980 cm⁻¹ and 850 cm⁻¹, which correspond to the presence of Si—O—Si. This shows that the interaction between the TPU matrix and GMB is completely in a physical manner.

### Porosity

The porosity of pure TPU-based syntactic foams was examined to determine the effect of introducing GMBs into the matrix during additive manufacturing. The porosity values for TPU, SF60-20, and SF60-40 foams remained constant, ranging between 27 and 28 percent. However, the SF60-60 foam was found to have a 38 percent porosity, which can be attributed to an insufficient matrix available to successfully bond together a high-volume fraction of GMBs. By increasing the energy density supplied to the system, the porosity values of GMB-containing foams can decrease, as was observed with the increase in cell wall thickness for pure TPU above. From FIG. 6, panels (a)-(f), it was also noticed that for the same volume fraction of GMBs, decreasing the size of the GMBs decreased the cell wall thickness, hence increasing the porosity of the foam. Increase in particle density of the TPU/GMB blend altered the transmittance and absorbance of the mixture as discussed above. This suggests that raising the energy density of the laser with increasing GMB content can decrease the porosity, as was observed in FIG. 6, panels (a)-(f). In other words, the same porosity can be achieved if higher energy density is supplied to a powder blend with smaller particles, as compared to low energy density supplied to a blend without particles—this phenomenon can also be observed in FIG. 6, panels (a)-(f). Having said that, the LPR in this Example was fixed to maintain the energy supplied as a constant.

### Mechanical Response

This section first discusses the effect of print parameters on the tensile properties of pure TPU foams. Then, the performance of syntactic foams printed with the chosen print parameters under tensile and compression loading with various volume fractions and GMB types is evaluated. In addition, failure morphologies are discussed to complement the response.

### Tensile Response

### Pure TPU Foams

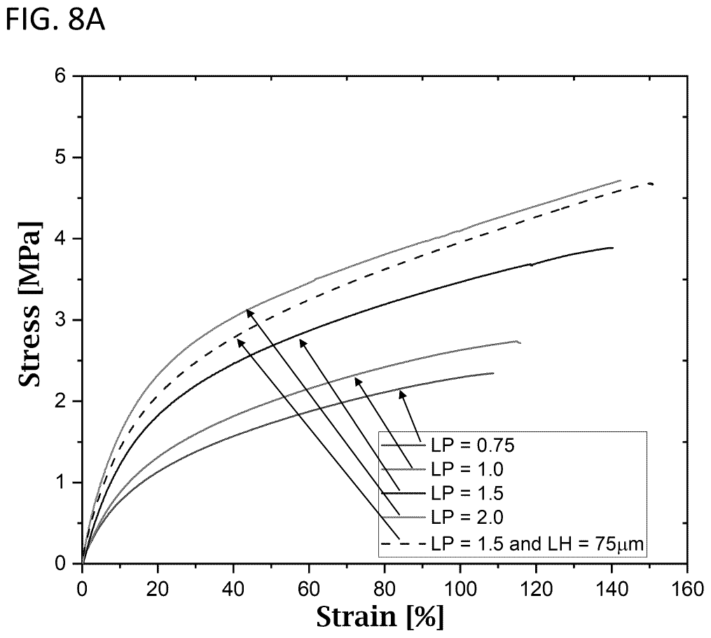

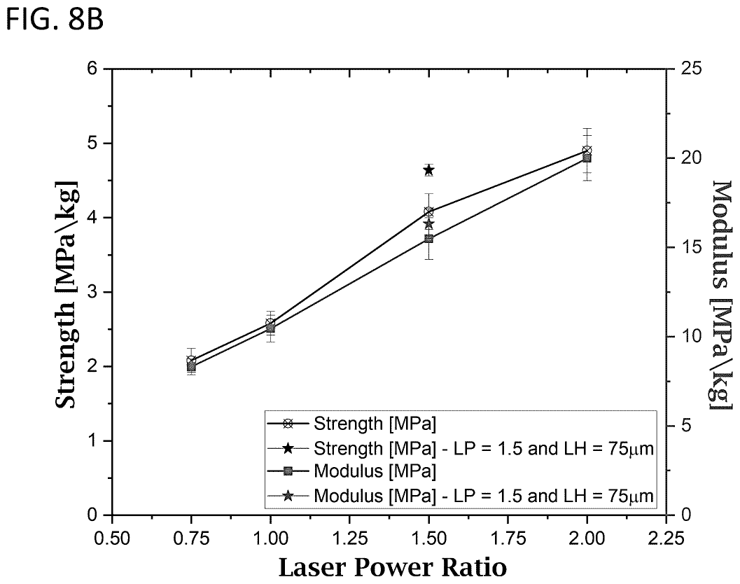

FIG. 8A shows representative stress-strain curves for all 3D printed pure TPU foams, and FIG. 8B summarizes tensile properties. These foams exhibited a small linear elastic region followed by a nonlinear ductile response when subjected to tension. By increasing the laser power ratio (LPR) at a constant layer height (LH) value of 125 μm, it was observed that the tensile modulus and strength increased for these foams. This is attributed to an increase in cell wall thickness with an increase in LPR, as observed in the SEM images in FIG. 5, panels (a)-(f). It was speculated that this increase in cell wall thickness results in higher resistance which increased the modulus. Additionally, the strength increased because of the increase in the load-bearing phase. Moreover, the increase in the cell wall thickness increased the strain to failure. However, with an increase in the energy density, it was also observed that the dimensional stability decreased, that is, z-bulging was observed. Therefore, to avoid this, a specimen was printed at a laser power ratio of 1.5 with a reduced layer height of 75 μm. When the layer height was decreased, tensile strength increased drastically by 10.87%, while tensile modulus increased moderately by 0.62%. The tensile strengths were comparable for the [LPR/LH] combination of [1.5/75 μm] and [2.0/125 μm]. This was attributed to the repeated sintering of layers as LH decreased, which increased the energy absorbed by individual layers and also, provided better bonding even with lower LPR.

The influence of the two parameters, LPR and LH, was integrated to determine optimal final print parameters for enhanced tensile response and high dimensional stability of the printed specimens. Considering the tensile performance, print duration, and printer limitations, a laser power ratio of 1.5 and a layer height of 75 μm were chosen for the final printing procedure.

Particle reinforced TPU Foams

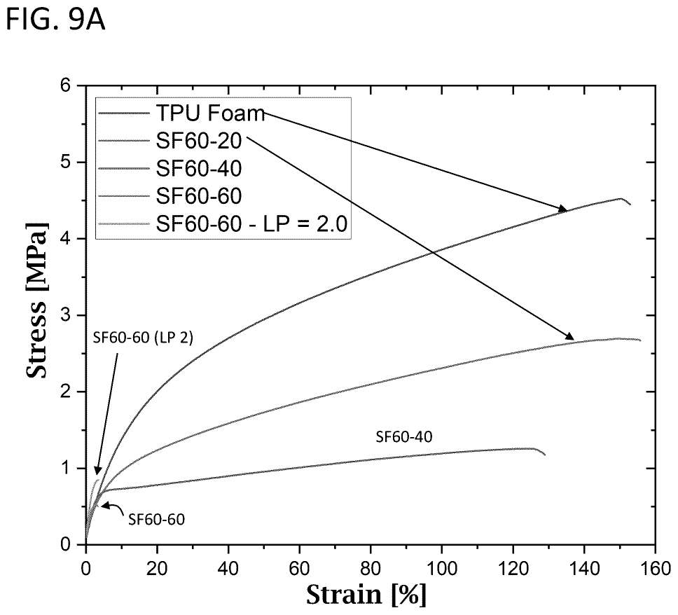

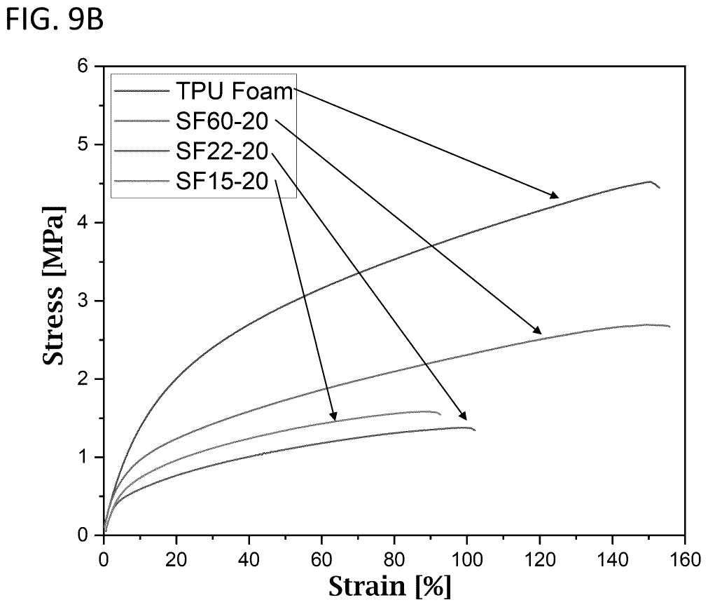

Using the final print parameters established for pure TPU foams, TPU/GMB syntactic foams were printed and tested under quasi-static tensile loading. FIG. 9A shows tensile stress-strain responses for SF60 foams with varying GMB volume fractions. The strength and strain to failure decreased with increasing GMB volume fraction with of the larger particles. This behavior can also be attributed to poor adhesion of the larger particles partially embedded (i.e., protruding) within a segregated matrix, resulting in debonding and insufficient load transfer. SF60-60 with 60% GMB volume fraction showed significantly poorer tensile strength and failure to strain properties compared to SF60-20 and SF60-40. This is due to the lack of TPU matrix to effectively bind the GMBs at very high-volume fractions. With regard to elastic modulus, it was seen that the values were in the range from 13 to 16 MPa for TPU, SF60-20, and SF60-40 foams. It was speculated that these small deviations were due to competing effects of stiffer GMB particles and reducing cell wall size with increasing GMB volume fraction. Even though the GMBs are stiffer than TPU, their effect is counteracted by a reduction in the cell wall thickness when printed with the same laser energy density.

FIG. 9B shows the tensile stress-strain responses of syntactic foams with three GMB particle sizes at 20% GMB volume fraction. It was observed that the tensile strength reduced when smaller GMBs (GM22 and GM15) than larger GMBs (GM60) at the same volume fraction were incorporated, rendering the foam quasi-brittle. This is attributed to two findings: 1) Smaller GMBs tend to get lodged in the cell walls, resulting in more stress concentration locations within the cell wall. 2) Smaller particles have higher particle density than larger particles for a fixed foam volume. Due to this higher particle density, the surface area of particles in contact with the matrix increased, resulting in debonding of more particles compared to that of the SF22-20 foams, thereby reducing the tensile strength. Tensile moduli values of SF22-20 and SF15-20 dropped to approximately 9 MPa compared to 14.1 MPa for the pure TPU foam. This reduction in moduli was attributed to the cell wall thickness reduction associated with higher particle density in SF22-20 and SF15-20 foams compared to that of SF60-20 as shown previously in FIG. 6, panels (a)-(f).

### Compressive Response

Uniaxial compression tests were performed to determine the mechanical response of pure and particle reinforced TPU foams. GM60 particles were selected, and the volume fractions were varied, ranging from 20% to 60% in increments of 20% to influence incorporation of the GMB particles into the segregated TPU matrix. Further, to understand the effect of particle size within the segregated structure of the matrix, GM22 and GM15 GMBs were chosen with volume fractions of 20% and 40%. In this Example, the compressive strength was chosen as the compressive stress value at 30% strain value.

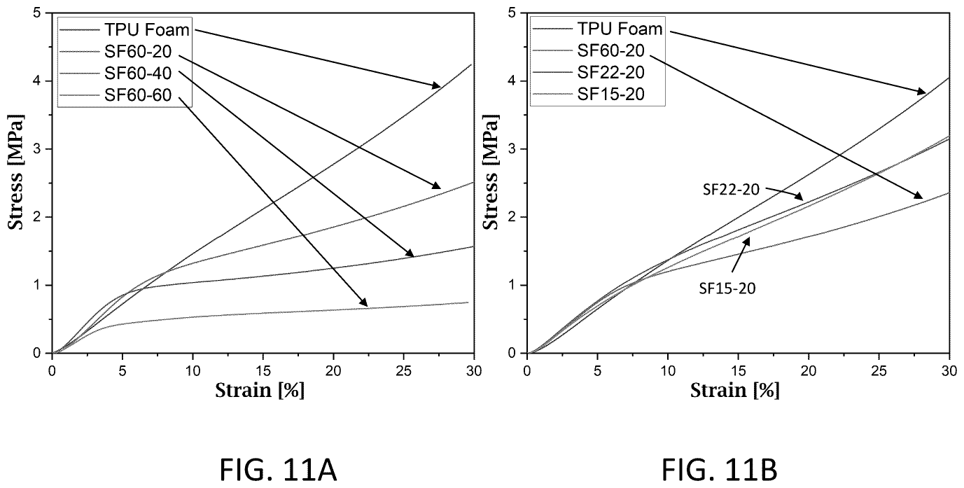

The stress-strain response for pure TPU foams resembled the non-linear behavior of typical foamed elastomers as shown in FIG. 10A. Due to the segregated matrix microstructure in these foams, a small elastic region was observed at the beginning, which was then followed by the elastic buckling zone where the cell walls started to buckle. As the air was pushed out of the foams, the cell walls began to compress on themselves, resulting in the densification zone. FIGS. 11A-11B show a representative compressive stress-strain response of printed TPU foam. By contrast, a schematic of a typical compressive stress-strain behavior for syntactic foams (FIG. 10B) consists of a very small initial linear region associated with the enhanced elastic modulus due to the presence of reinforcing particles. This was followed by a second zone called the plateau region, corresponding to reduced stiffness due to particle cell wall buckling and crushing. Finally, the third zone, known as the densification region, occurred when the cell walls of the matrix and the particles compressed.

### Different GMB Volume Fractions

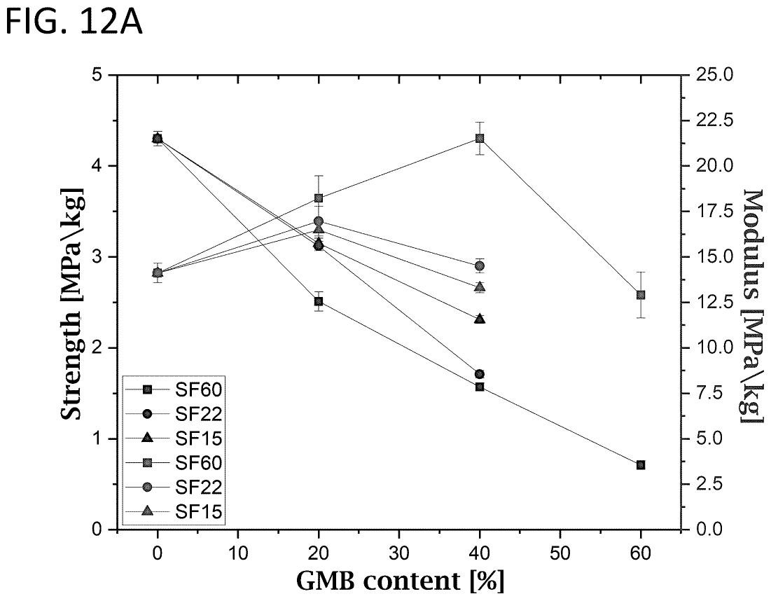

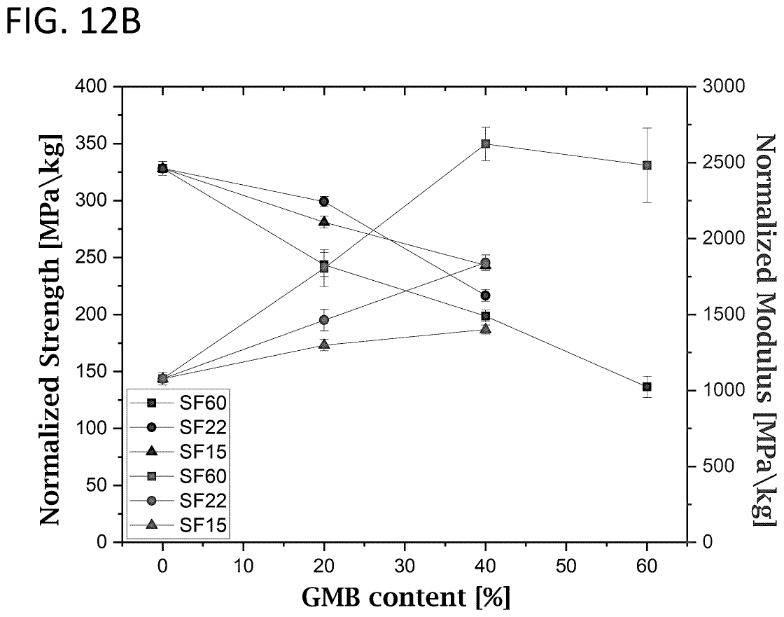

FIG. 11A shows the representative compressive stress-strain responses of SF60 foams with varying GMB volume fractions. In general, these responses exhibited an initial elastic region associated with the enhanced compressive modulus compared to the pure TPU foams in this region. This is attributed to the large particles lodged within and between the cell walls, resulting in cell wall stiffening as well as creating stiff bridges between the cell walls of the segregated matrix. However, it was observed that the modulus reduced in SF60-60 foams due to insufficient matrix material available to bond these GMBs for effective load transfer to occur. At strain values beyond this initial region, a knee formation was observed due to the initiation of particle crushing present in the gaps of the segregated matrix. A dominant plateau region after this knee formation is a characteristic behavior of particle crushing as discussed above in reference to FIG. 10B. It was observed that the densification region was lower than that of the pure TPU foams, and it was further reduced with increasing GMB volume fraction. This is because of the lower crushing strength of GM60 particles. The modulus and strength for SF60 foams are summarized in FIGS. 12A-12B using square markers.

### Different GMB Grades

FIG. 11B shows compressive stress-strain responses of syntactic foams with different GMB size particles (GM60, GM22, and GM15) at 20% volume fraction. With decreasing GMB size (GM22 and GM15), the compression behavior approached that of the pure TPU foam, and the plateau region disappeared compared to the TPU foam with larger particles (GM60). It was speculated that this response reflects the dominance of matrix material and involves no particle crushing. Since the smaller particles are fully embedded within compliant TPU matrix cell walls, it will take larger strains to sufficiently compress the particles within the cell walls to reach their crushing strengths. Although the crushing strength of GM15 is higher than that of GM22, similar responses of SF22 and SF15 foams were seen, as smaller particles embedded within the TPU matrix never reached high stresses to crush the particles. Further, from FIG. 11B, it was observed that the densification stress for foams SF22 and SF15 foams was less than that of the pure TPU foam. This can be attributed to an increase in porosity (reduced cell wall thickness) when smaller GMBs were used for printing the syntactic foams as discussed above. As a result, the SF22 and SF15 foams reached the densification stage at a higher strain value compared to the pure TPU foams.

From summary plots shown in FIGS. 12A-12B, the compressive modulus for SF22-20 and SF15-20 foams increased at GMB volume fraction of 20%. This was due to an increased stiffness of the cell walls due to the embedded stiff GMBs. However, a dip in the moduli values for these foams was observed at a volume fraction of 40%, much earlier than that observed at 60% for SF60 foams. The particle packing density in the cell walls increased as the particle size decreased, which consequently increased the surface area of the embedded particles. Hence, at a 40% volume fraction of smaller particles, the quantity of the matrix was insufficient to transfer loads effectively between the reinforcing particles, whereas larger particles at a higher volume fraction of GMBs can be incorporated in the matrix before the foam's compressive modulus drops.

Therefore, with the decrease in the size of GMBs, the volume fraction corresponding to the peak compressive modulus shifted to a lower value as summarized in FIG. 12A. When the compressive moduli were normalized (FIG. 12B), although there was no dip for SF15-40, the increase was not as significant as that which manifested in SF60-40 and SF22-40.

### Densification Mechanics of TPU Foams

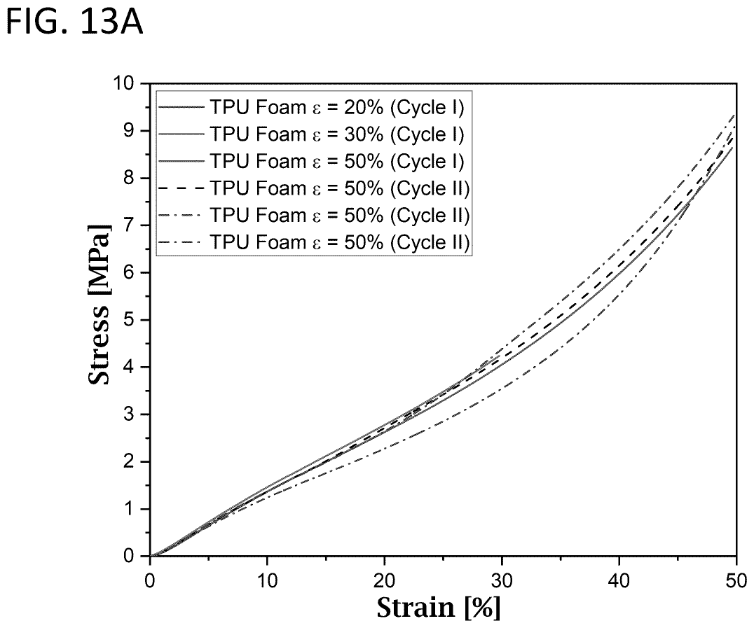

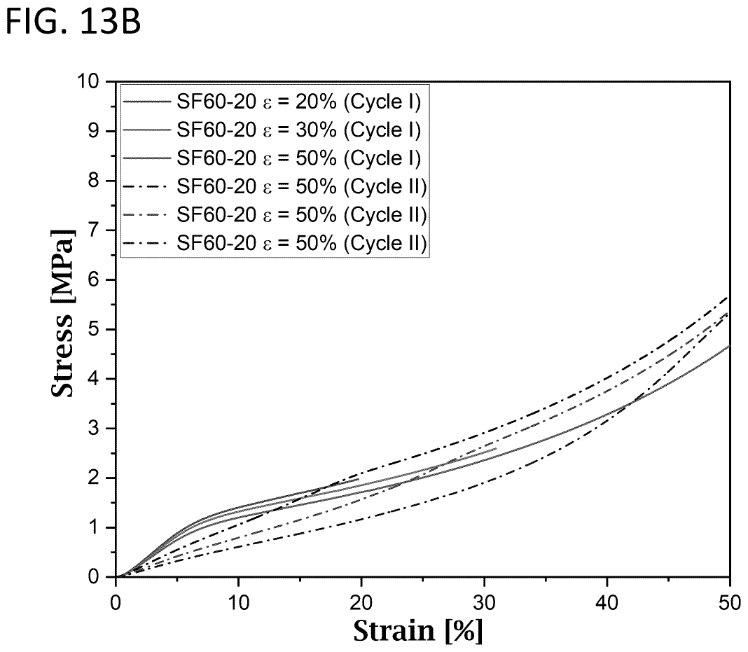

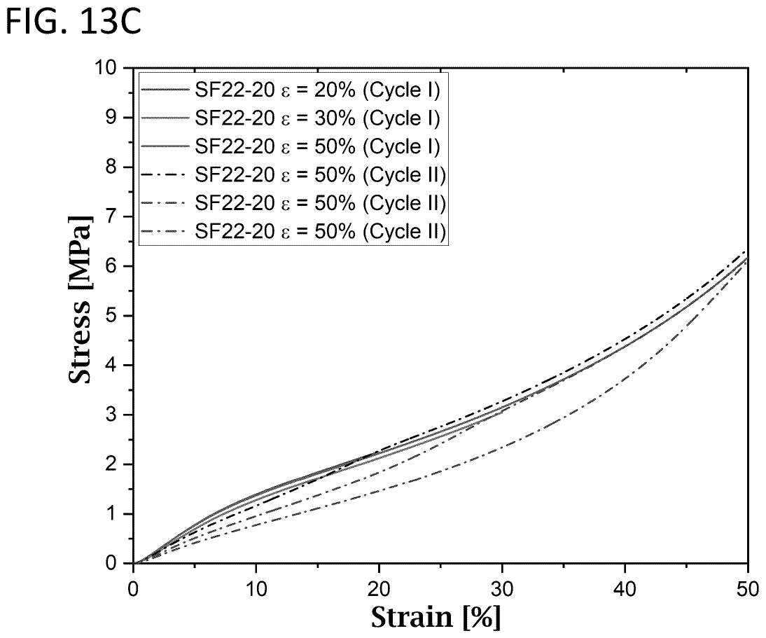

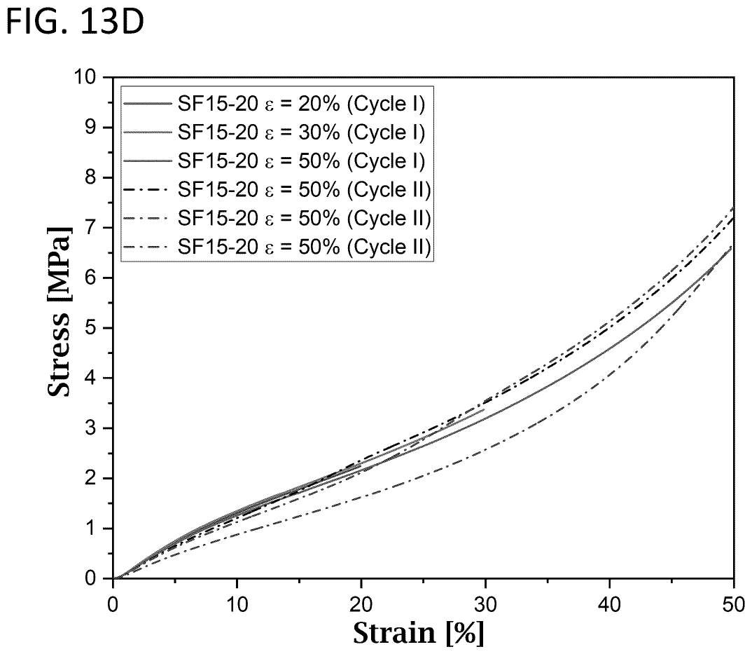

The residual performance of TPU, SF60-20, SF22-20, and SF15-20 foams was evaluated under cyclic loading to evaluate the densification mechanics. In the first cycle, each set of samples was subjected to 20%, 30%, and 50% strain values before they were allowed to relax for one week. After a one-week interval, all samples were loaded to 50% strain values. FIGS. 13A-13D display the stress-strain responses of the pristine and compressed foams for all samples. The solid lines represent the stress-strain response of pristine foams, and the dashed lines represent the response of compressed foams. Further, black, red, and blue lines represent compression to 20%, 30%, and 50% strain, respectively, in the first cycle.

For pure TPU foams, both pristine and compressed foams exhibited comparable compressive behavior and a marginal increase in the densification stress. This is because they became denser after the initial compression cycle. During the second cycle, the cell walls were closer to achieving densification compared to the first cycle. When the TPU foam was loaded to 50% strain in the first cycle, there was a reduction in the plateau region that can be attributed to the weakening of the cell walls in the segregated matrix structure caused by excessive deformation at 50% strain. The compressive response of SF60-20 deteriorated significantly after the first cycle followed by SF22-20. The greatest moduli reduction was observed for samples loaded to a 50% strain value during the first cycle. This response can be attributed to the crushing of GMBs during the first compression cycle of SF60-20 foams. When SF60-20 foams were compressed again, there were fewer particles to support the load and the porosity had increased as a result of the first cycle's particle crushing. For SF22-20 foams, the reduction was not due to particle crushing; however, when these foams were loaded, the particles extending from the cell walls may have been compressed against one another. Particles in SF22-20 foams may have interacted at lower strain values, resulting in debonding from the matrix and a reduction in residual properties during the second cycle. The compressive properties of SF15-20 foams that were loaded to strain values of 20% and 30% in the first cycle did not degrade. However, a significant decrease was observed for the foam that was loaded to 50% strain in the initial cycle. This is because, as discussed above, particles in SF15-20 foams began to interact at higher strain values. This may have resulted in particle detachment from the TPU matrix at the interaction site. Therefore, a decrease in properties for SF15-20 foams was only observed when the foam was loaded to 50% strain in the first cycle.

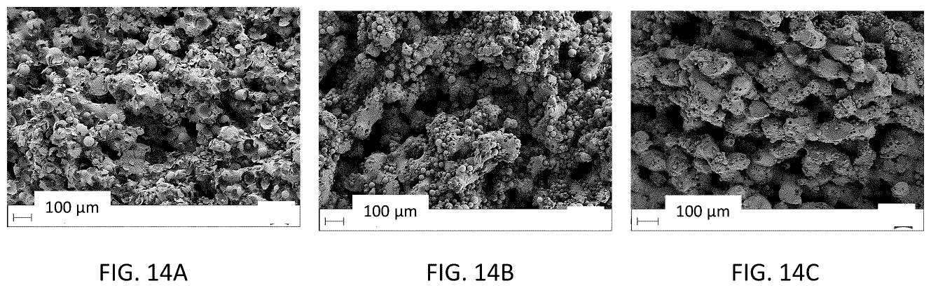

FIGS. 14A-14C show the SEM morphologies of the syntactic foams compressed twice to 50% strain with a gap of 1 week between each loading cycle. Particle crushing was significant for SF60-20 foam. However, the particles remained intact and did not undergo any crushing in SF22-20 and SF15-20 foams. With increasing compressive strain values, porosity values also increased for SF60-20 foam due to the crushing of GMBs. However, in the case of SF22-20 and SF15-20 foams, the porosity values were in the same zone, showing no particle crushing was involved during the compression cycle. When SF22-20 foam was loaded twice, the SEM morphology shows that particles were too small to fit in the gaps, but they can still start to interact in the initial stages of compression loading. However, for SF15-20, it can be seen that, due to the smallest size of GMBs, the particles can interact in the densification region. Although particles in SF22-20 and SF15-20 foams can interact at some stage during compression loading, they will not crush due to their extremely high strength in comparison to the TPU matrix.

### Process—Structure—Property Map

Based on the inventors' observations, a Process—Structure—Property map (FIG. 15) was prepared to assist with designing SLS-printed syntactic foams. This map depicts how the energy density supplied during manufacturing, GMB size and volume fraction, and associated internal microstructure influence the foam compressive modulus and strength. The map shows that matrix segregation manifested during the SLS process reduces with increasing laser energy density for a pure TPU matrix. Higher energy density is required for syntactic foams as compared to pure TPU to achieve a similar extent of matrix segregation. For syntactic foams, it was observed that the compressive modulus of syntactic foams with segregated matrix increases with increasing volume fraction up to a certain percentage, beyond which this value drops. The optimum volume fraction that achieves the peak compressive modulus reduces with reducing particle size. In addition, the compressive modulus with larger particles was higher than that with lower particles for syntactic foams with segregated matrix. The values will converge as a solid matrix is approached with increasing energy density. On the other hand, there was a switch in compressive strength behavior. Higher strength is achieved with smaller particles in a segregated matrix at lower energy densities, and the responses diverge when a solid matrix is approached.

### Demonstration—Compression Response of Architected Syntactic Foams

To demonstrate hierarchy at the macroscale, architected syntactic foams were manufactured with the dimensions of 25 mm×25 mm×25 mm. Three architectures were chosen, namely: i) gyroid, ii) diamond, and iii) conical as shown in FIG. 16. The effective strain and effective stress were calculated by using the dimensions as mentioned above. These effective properties represent the response of the overall architected structures and not of the local struts. Representative stress-strain compressive responses of all architected syntactic foams—gyroid, diamond, and conical—are summarized in Table 4 and Table 5. The gyroid and diamond architectures were observed to exhibit bending-dominated stress-strain behavior, whereas the conical architecture displayed a buckling dominated (stretching-dominated) behavior.

TABLE 4
Compressive stiffness of architected TPU and SF60-40 foams

| Material | Gyroid Geometry | Diamond Geometry | Conical Geometry |
|---|---|---|---|
| TPU | 1.06 ± 0.062 MPa | 1.46 ± 0.08 MPa | 0.46 ± 0.012 MPa |
| SF60-40 | 2.22 ± 0.122 MPa | 3.03 ± 0.014 MPa | 0.77 ± 0.083 MPa |
| % Change | 109.43% | 107.53% | 67% |
| % Normalized | 215.61% | 193.12% | 103.7% |
| Change | | | |

TABLE 5
Compressive strength of architected TPU and SF60-40 foams

| Material | Gyroid Geometry | Diamond Geometry | Conical Geometry |
|---|---|---|---|
| TPU | 0.158 ± 0.03 MPa | 0.23 ± 0.006 MPa | 0.014 ± 0.0005 MPa |
| SF60-40 | 0.11 ± 0.002 MPa | 0.17 ± 0.005 MPa | 0.018 ± 0.0004 MPa |
| % Change | −30.38% | −26.09% | 8.9% |
| % Normalized | 3.68% | 6.63% | 32.5% |
| Change | | | |

Table 4 shows that after incorporating GMBs into bending-dominated architectural designs, the stiffness increased with an increase in GMB volume fraction from 0% to 40%. This was attributed to an increase in the bending stiffness of the struts due to the addition of GMBs, which consequently increased the stiffness of the diamond and gyroid foams. Furthermore, the stiffness increased for the buckling-dominated architected foam with the addition of GMBs. Table 5 shows a decrease in strength of the bending-dominated architected foams, whereas it increased for buckling-dominated architecture. The decrease in the bending-dominated architectures was attributed to the crushing of GMBs with lower crushing strength after the struts compressed against each other. However, considering the weight reduction associated with the addition of GMBs, the GMB reinforced gyroid and diamond foams showed strength that was comparable to pure TPU foam. By contrast, the compressive strength increased as the GMB volume percentage increased in the case of the conical foams. This is because the strength value for buckling-dominated structures depends on the struts' stiffness.

### CONCLUSION

This Example presents a study on the mechanics of additively manufactured syntactic foams having a segregated matrix. It shows how additive manufacturing parameters can be coupled with GMB parameters to achieve the desired mechanical response or to tune the mechanical response of syntactic foams with segregated matrix. To that end, this Example proposes an additive manufacturing technique for producing lightweight syntactic foams composed of a segregated Thermoplastic Polyurethane (TPU) matrix and Glass MicroBalloons (GMBs), which can be extended to the production of lightweight syntactic foams with intricate architectural designs. The effect of print parameters on the mechanical response of the structures was evaluated. Additionally, the effects of incorporating various grades of GMBs at various volume fractions were evaluated and discussed. The compression responses of two categories of architectures, bending-dominated and stretching-dominated, were studied for architected syntactic foams. Key conclusions from this work can be summarized as follows:

The effect of print parameters was explored, namely, laser power ratio and layer height, on the mechanical properties of TPU foams produced via powder-based SLS printing. The laser power ratio directly affected the supplied energy density to the powder system, and increasing this value increased the size of the melt pool. However, layer height played a significant effect in the adhesion between successive layers of a printed object. Reducing the value of this parameter enhanced the quality of the interlayer bond.

It was shown that altering the GMB parameters affected not only the mechanical properties of the printed foam, but also the behavior of these foams under various loading conditions. The effect of adding different grades of GMBs on the energy density absorbed by the TPU powder was observed; smaller GMBs required a greater energy density to compensate for a higher particle per area density compared to bigger GMBs.

During the SLS process, the influence of adding various grades of GMBs on the energy density absorbed by the TPU powder was investigated. At the same energy density provided, it was discovered that smaller GMBs in powder blends absorbed more energy due to a larger particle density per area, hence decreasing the energy of the TPU powder. This led to a decrease in the cell wall thickness of the TPU matrix and a delay in the densification stage of the foam under compression. Consequently, blends with smaller GMBs require a greater energy density to compensate for a higher particle per area density than blends with bigger GMBs. Here, it was established that the GMB parameters and the print parameters must be coupled in order to attain the desired mechanical performance.

The deformation mechanics were distinct when larger particles were embedded versus smaller particles. When larger GMBs were added that can get lodged within and between the cell walls of the segregated TPU matrix, particles in the gaps created a quasi-bridge between the cell walls which manifested an initial linear region, followed by the knee formation and particle crushing. With smaller GMBs embedded predominantly in the cell walls, the stress-strain response was comparable to that of pure TPU foams, and the response was matrix dominated with no noticeable particle crushing.

Under repeated compression loading, the mechanical characteristics of foams with GMBs lodged between and within the cell walls (larger particles with lower crushing strength) degraded after the first cycle. However, the properties of the foams with GMBs in the cell walls (smaller particles with higher crushing strength) were preserved during the second cycle. Consequently, GMB sizes and grades can be chosen on the basis of the application to achieve the desired response.

In addition, it was demonstrated that stiffer and lighter syntactic foams with a multi-scale architectural hierarchy can be fabricated using the disclosed approach. For architectures with bending-dominated deformations, it was observed that GMBs can increase the compression modulus. In contrast, the addition of GMBs enhanced compression modulus and strength for structures exhibiting stretching-dominated response.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A method of fabricating a syntactic foam object, the method comprising:
(a) illuminating a region in a layer of a precursor powder comprising thermoplastic elastomer particles and hollow particles with a laser beam of a selective laser sintering system (SLS) to convert the region to a porous, sintered region comprising the hollow particles and a solid thermoplastic elastomer matrix having a surface that defines pores distributed throughout the porous, sintered region.

2. The method of claim 1, further comprising (b) repeating step (a) one or more additional times in one or more additional layers, each layer comprising the precursor powder, to provide one or more additional porous, sintered regions.

3. The method of claim 1, wherein the thermoplastic elastomer particles comprise thermoplastic polyurethane elastomer particles, thermoplastic polyamide elastomer particles, or thermoplastic copolyester elastomer particles.

4. The method of claim 1, wherein the hollow particles comprise glass microbubbles, cenospheres, or metal-coated ceramic particles.

5. The method of claim 1, wherein the thermoplastic elastomer particles comprise thermoplastic polyurethane elastomer particles and the hollow particles comprise glass microbubbles.

6. The method of claim 1, wherein the hollow particles in the porous, sintered region comprise embedded hollow particles.

7. The method of claim 6, wherein the hollow particles in the porous, sintered region consist of embedded hollow particles.

8. The method of claim 1, wherein the hollow particles in the porous, sintered region comprise protruding hollow particles.

9. The method of claim 1, wherein the hollow particles in the porous, sintered region comprise embedded and protruding hollow particles.

10. The method of claim 9, wherein the embedded hollow particles have diameters smaller than diameters of the protruding hollow particles.

11. The method of claim 1, wherein the hollow particles in the precursor powder comprise hollow particles characterized by a first D₅₀ particle size and hollow particles characterized by a second, different D₅₀ particle size.

12. The method of claim 1, wherein the porous, sintered region is characterized by a porosity in a range of from 20% to 40%.

13. The method of claim 1, wherein step (a) is carried out under a value of a parameter selected from an energy density of the laser beam, a D₅₀ particle size of the hollow particles in the precursor powder, a volume fraction of the hollow particles in the precursor powder, or combinations thereof, wherein the value is determined from a calibration plot of compressive modulus or compressive strength as a function of each parameter.

14. The method of claim 1, wherein the hollow particles in the precursor powder have a D₅₀ particle size, a volume fraction, or both, selected to provide the porous, sintered region with a predetermined compressive strength or a predetermined compressive modulus.

15. The method of claim 14, wherein the D₅₀ particle size, the volume fraction, or both, are selected from a calibration plot of compressive strength and compressive modulus as a function of the D₅₀ particle size and the volume fraction.

16. The method of claim 13, wherein the method further comprises generating the calibration plot.

17. A syntactic foam object comprising a porous, sintered region formed by illuminating a region in a layer of a precursor powder comprising thermoplastic elastomer particles and hollow particles with a laser beam of a selective laser sintering system (SLS), wherein the porous, sintered region comprises the hollow particles and a solid thermoplastic elastomer matrix having a surface that defines pores distributed throughout the porous, sintered region.

18. The syntactic foam object of claim 17, wherein the porous, sintered region is one of a plurality of porous, sintered regions in the syntactic foam object, each porous, sintered region formed in a different layer of the precursor powder.

19. The syntactic foam object of claim 17, wherein the thermoplastic elastomer particles comprise thermoplastic polyurethane elastomer particles, thermoplastic polyamide elastomer particles, or thermoplastic copolyester elastomer particles and the hollow particles comprise glass microbubbles, cenospheres, or metal-coated ceramic particles.

20. A helmet or footwear comprising the syntactic foam object of claim 17.
